(19) United States
(12) Patent Application Publication
(10) Pub. No.: US 2005/0213567 A1
(43) Pub. Date: Sep. 29, 2005

(54) Method and system for providing voice over internet protocol telephony products

(76) Inventors: Samuel R. Mullins, Iowa City, IA (US); Jonathan M. Scheele, Arlington, VA (US); Douglas H. Weeks, Reston, VA (US); Steven E. Carter, Purcellville, VA (US); Benjamin J. Herrera, Falls Church, VA (US)

Correspondence Address: Barnes & Thornburg LLP;Suite 900, 750 17th Street, N.W., Washington, DC, 20006, US

(21) Appl. No.: 11/078,732

(22) Filed: Mar. 14, 2005

Related U.S. Application Data
(60) Provisional application No. 60/555,321, filed on Mar. 23, 2004.

(51) Int. Cl. H04L 12/66

(52) U.S. Cl. 370/352

(57) ABSTRACT

A method and system for providing Voice over Internet Protocol (VoIP) telephony products to purchasers is disclosed herein. Purchasers of the VoIP products are provided VoIP telephony calling capability via an ITSP VoIP system. The method and system include providing an online tool to the purchasers where the online tool enables online purchasing of each of the VoIP telephony products. The method and system further include detecting an order for a VoIP product(s) by a purchaser via the online tool where the order includes data for provisioning the VoIP product in the ITSP network, forwarding the order to the ITSP network and receiving an order confirmation from the ITSP network. The order confirmation indicates successful purchasing and provisioning of the VoIP product. The purchaser may be a reseller who resells the VoIP products to an end customer. Alternatively, the purchaser may be the end customer.

### CROSS-REFERENCE TO RELATED APPLICATIONS

This application claims benefit under 35 U.S.C. section 119(e) from co-pending U.S. Provisional Patent Application No. 60/555,321, filed Mar. 23, 2004, naming Jonathan M. Scheele, Samual R. Mullins, Douglas H. Weeks, Steven E. Carter and Benjamin J. Herrera as inventors, and titled “METHOD AND SYSTEM FOR PROVIDING VOICE OVER INTERNET PROTOCOL PRODUCTS”.

### FIELD OF THE INVENTION

This invention is directed to a method and system for providing telephony services, and more particularly, to a method and system for providing Voice over Internet Protocol (VoIP) telephony products.

### BACKGROUND

Modern day telephony can be traced back to a day in 1876 when Alexander Graham Bell's uttered the words, “Come quickly Watson, I need you” over what became known as the first telephone. As the demand for telephones and associated infrastructure increased, the required number of connections became unwieldy. Providers of telephone service (service providers) began routing voice calls through local electromechanical switching systems housed in central offices (CO). Such older switching systems included crossbar switches configured to complete connections between input and output telephone lines. Of course, as the number of central offices grew commensurate with the increased call traffic, switching equipment became more sophisticated.

In the early 1980's digital switching systems designed to carry digital traffic, including voice and data, began replacing the older electromechanical switching systems. Accordingly, signaling protocols, and control and switching functionality became more robust, and improved digital transmission methods using trunk carriers (T-carriers) such as T1, T2, T3, T4, etc., became prevalent. For example, an originating analog telephone signal was converted into a digital signal, transmitted via a T1 carrier using one of any number of protocols (e.g., time division multiplexing (TDM)), digitally switched at the central office(s) and converted back into an analog signal by the class 5 local end office switch at the destination end.

Usage charges, including long distance tariffs, typically depended on telephone network usage which was proportional to the amount of time used and the distance of the called party from the originating calling party. As a result, telephone users desiring to keep telephone usage costs to a minimum either decreased the amount or duration of long distance calls made or they (e.g. businesses) subscribed to flat rate services enabled by wide area telephone service networks.

In the early to mid-1990's, computer technology and telephony began to converge with the addition of modems for transmitting data from one computer to another via the telephone infrastructure, or the public switched telephone network (PSTN). Internet Service Providers (ISPs) also began providing Internet subscriber's access to the Internet for a fee. As the number of computer terminals increased and Internet data traffic increased, Internet computer networks, interlinked via network hubs, expanded significantly. Over time, traditional low-speed dial-up connections gave way to higher speed modems. Again, charges for telephone line usage were predicated on the amount of time used and the distance along the PSTN from the originating calling party to the ISP.

The resulting increased data traffic needs were addressed, in part, by fiber optic links that provided higher and more efficient bandwidth usage. With the increase in available bandwidth, reduced data latency and with the proper software, it became possible to bypass the PSTN used by traditional phone carriers and use the Internet to carry voice calls. This is known as voice delivery using the Internet Protocol (IP). Typical telephone usage charges could therefore be replaced by the lower-priced usage charges offered by an ISP.

The early days of Voice over Internet Protocol (VoIP) were marred by poor audio quality provided by the earlier VoIP protocols. To remedy this, a variety of protocols evolved under the guidance of various standards committees (e.g., Internet Engineering Task Force, International Telecommunications Union) and industry leaders. One of these protocols referred to as the real-time protocol (RTP), primarily addressed Quality of Service (QoS) issues by ensuring data packet delivery in a timely and predictable fashion.

Unfortunately, even with RTP, it is difficult to guarantee QoS using PSTN. Optimal VoIP service is possible however, using private networks managed by an Internet telephony service provider (ITSP) such as Primus Telecommunications, Inc. Because proper equipment selection, calibration and maintenance of servers, routers, switches, etc., by the ITSP allows ITSP equipment performance to be monitored and data capacity to be managed, the ITSP can deliver QoS superior to that which is provided by the public networks.

In the mid- to late-1990's VoIP was available to “hobbyists” who outfitted their personal computers with the necessary VoIP access software and hardware (e.g., speaker, microphone, etc.). VoIP calling was then possible via their personal computer to other suitably configured computers. Thus, in addition to the poor audio quality achievable in the early days of VoIP, both the caller and the called party were required to coordinate calling times and have access to their personal computer and the Internet.

As VoIP technology became more sophisticated, PSTN phones in conjunction with small adapter devices, such as an analog telephone adaptor, dispensed with the need for specialty configured personal computers when placing a VoIP call. As a result, the market for VoIP calls has expanded beyond the hobbyists to mainstream consumers wishing to save money is on long distance phone calls. A number of methods and systems have been proposed that seek to capitalize on the expanding VoIP market.

One such method and system disclosed in U.S. Pat. No. 6,714,535 to Herh, entitled “Method and System for Unlimited Use of Telephony Services Over a Data Network Without Incurring Long Distance Calling Tolls” (“the '535 patent”) discloses a method for providing IP telephony services to individual customers over a data network and a method for providing telephony services to various locations of an entity. The individual customers and entities enter into a service plan with an IP service provider. The service plan allows unlimited use of the IP telephony services supported by the IP service provider who maintains a gatekeeper to provision subscribed customers and entities and to facilitate data flow of its subscribed customers and entities.

The service plan described in the '535 patent contemplates monthly or periodic payments by the subscribed customer for a predetermined time period. This, of course puts the onus on the service provider to provide both personnel and systems to track monthly or periodic billing and payments. In addition, the costs associated with providing such personnel and systems are passed along to the subscribed user.

The system configuration disclosed in the '535 patent includes the use of gateway phones that are adapted to function as a “regular” telephone yet include a network function or computing device capable of data communication through a data network interface with any data processing devices. The gateway phones are coupled to and located somewhere between the data network (e.g., the Internet) and a respective telephone network to ensure that the subscribed customer is charged only for a local call to be connected to a gateway phone. Thus the gateway phones are not necessarily co-located with the subscribed customers and entities. As a result, the subscribed customer may not have the ability to take advantage of their VoIP service from a location remote from the gateway phone because the gateway phone is not necessarily portable.

### SUMMARY OF THE INVENTION

In general, a method and system for providing Voice over Internet Protocol (VoIP) telephony products to purchasers is disclosed herein. Purchasers of the VoIP products are provided VoIP telephony calling capability via an ITSP network. The method and system includes providing an online tool to the purchasers where the online tool enables online purchasing of the VoIP telephony products. The method and system further includes detecting an order for a VoIP product(s) by a purchaser via the online tool, forwarding the order to the ITSP network and receiving an order confirmation from the ITSP network. The order includes data for provisioning the VoIP product in the ITSP network. The order confirmation indicates successful purchasing and provisioning of the VoIP product. The purchaser may be a reseller who resells the VoIP products (“resellers”) to an end customer. Alternatively, the purchaser may be the end customer.

Specifically, an embodiment of the invention discloses a method and system by which the ITSP sells VoIP products to resellers. The VoIP products are preferably purchased from the ITSP via one of a number of prepayment plans. It is contemplated that the VoIP products may also be purchased from the ITSP via one of a number of line-of-credit plans. The resellers can then provision and resell, at a profit, VoIP products in the form of provisioned VoIP products in smaller increments to an end customer (“customer”). VoIP phone calls associated with the customer, both incoming and outgoing, may then be routed via the ITSP's global IP network, resulting in a substantial cost savings to the customer, and possibly to the customer's caller, as compared to traditional telephone usage charges.

Another embodiment of the present invention discloses a method and system by which an ITSP sells provisioned VoIP products directly to consumers.

In addition to providing a lower cost alternative to traditional telephony, the method and system of providing VoIP telephony products according to the disclosed invention precludes the need for the ITSP to maintain personnel and systems to track monthly or periodic billing and payments associated with customers. Instead, in one embodiment the reseller preferably “pre-pays” the ITSP for their VoIP products. The reseller can then structure their sales relationship with the end customer without negative financial impact to the ITSP.

The method and system of providing internet VoIP products according to the disclosed invention also permits the customer to easily relocate their VoIP call origination location by simply moving their provisioning device (e.g. an ATA) to that location. Moreover, unlike other prior art methods and systems, the disclosed invention permits the customer to call virtually any PSTN phone, either landline or wireless, from their PSTN phone. BRIEF

### DESCRIPTION OF THE DRAWINGS

FIG. 1 is a high level block diagram of a Session Initiation Protocol based (SIP) VoIP architecture employing an embodiment of the disclosed invention.

FIG. 2 is another block diagram of a SIP based VoIP architecture incorporating the architecture of FIG. 1.

FIG. 3 is a block diagram of a number of components that may be incorporated in one or more servers illustrated in FIG. 2.

FIG. 4 is a flowchart of a method for providing and provisioning VoIP products according to an embodiment of the disclosed invention.

FIG. 5 is an exemplary sequence diagram for provisioning the VoIP products with an associated provisioning device provided by the ITSP.

FIG. 6 is an exemplary sequence diagram for provisioning the VoIP with an associated provisioning device provided by the customer.

FIGS. 7-9 are a series of flowcharts of a method for providing VoIP products via an online reseller management tool provided by the ITSP using the SIP based VoIP architecture of FIG. 2.

FIG. 10 is a screen shot of an exemplary reseller login page of the online reseller management tool.

FIG. 11 is a screen shot of an exemplary reseller password reminder page of the online reseller management tool.

FIG. 12 is a screen shot of an exemplary reseller password reset page of the online reseller management tool.

FIG. 13 is a screen shot of an exemplary reseller VoIP services page of the online reseller management tool.

FIG. 14 is a screen shot of an exemplary product information page of the online reseller management tool.

FIG. 15 is a screen shot of an exemplary product order page of the online reseller management tool.

FIG. 16 is a screen shot of an exemplary equipment provider information order page of the online reseller management tool.

FIG. 17 is a screen shot of an exemplary customer provided equipment information order page of the online reseller management tool.

FIG. 18 is a screen shot of an exemplary ITSP configuration order page of the online reseller management tool.

FIG. 19 is a screen shot of an exemplary DID configuration order page of the online reseller management tool.

FIG. 20 is a screen shot of an exemplary summary order page of the online reseller management tool.

FIG. 21 is a screen shot of an exemplary reseller customer list page of the online reseller management tool.

FIG. 22 is a screen shot of an exemplary balance information page of the online reseller management tool.

FIG. 23 is a screen shot of an exemplary trouble ticketing page of the online reseller management tool.

FIG. 24 is a screen shot of an exemplary trouble ticket query page of the online reseller management tool.

FIG. 25 is a screen shot of an exemplary trouble ticket results page of the online reseller management tool.

FIG. 26 is a screen shot of an exemplary trouble ticket page of the online reseller management tool.

FIG. 27 is a flowchart of a method for providing online customer access to information associated with their provisioned VoIP products according to an embodiment of the present invention.

FIG. 28 is a screen shot of an exemplary customer login page of the online customer tool.

FIG. 29 is a screen shot of an exemplary customer password reminder page of the online customer tool.

FIG. 30 is a screen shot of an exemplary customer CDR page of the online customer tool.

FIG. 31 is a screen shot of an exemplary FAQ page of the online customer tool.

FIG. 32 is a screen shot of an exemplary installation guide selection page of the online customer tool.

FIG. 33 is a flowchart of a reseller initiated remedy routine according to an embodiment of the present invention.

FIG. 34 is a screen shot of an exemplary VoIP trouble ticket page associated with the reseller initiated remedy routine of FIG. 34.

FIG. 35 is a screen shot of an exemplary selectable SIP information page associated with the reseller initiated remedy routine of FIG. 34.

### DETAILED DESCRIPTION OF THE INVENTION

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings. For example, although described herein as a method and system for providing VoIP products to resellers of VoIP products, it is contemplated that VoIP products could also be sold directly to the end customer, using similar methods and systems.

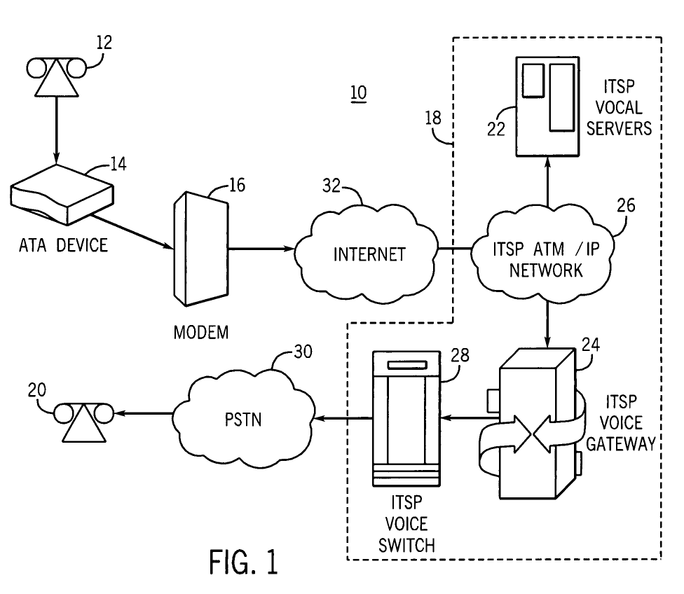

FIG. 1 is a high level block diagram of a Session Initiation Protocol (SIP) based VoIP architecture 10 employing an embodiment of the present invention. Although call set-up, routing and authentication are preferably enabled using SIP in the VoIP architecture 10, it is contemplated that other call set-up protocols may be utilized in the VoIP architecture 10.

Referring to FIG. 1, the VoIP architecture 10 includes a customer PSTN phone 12, a provisioning device 14, for example an analog telephone adaptor (ATA) device coupled to the customer PSTN phone 12, a broad band modem 16 (e.g., cable modem) coupled to the provisioning device 14, an ITSP VoIP system 18 and a called party PSTN phone 20. The ITSP VoIP system 18 includes one or more ITSP vocal server(s) or a vocal softswitch 22, an ITSP voice gateway 24 (e.g., a Cisco AS5300) coupled to the vocal softswitch 22 via an ITSP Asynchronous Transfer Mode/IP (ATM/IP) network 26, and an ITSP voice switch 28. In the illustrated example, the called party PSTN phone 20 is coupled to the ITSP VoIP system 18 (at the ITSP voice switch 28) via the PSTN 30, and the customer PSTN phone 12 is coupled to the ITSP VoIP system 18 (at the ITSP ATM/IP network 26) via the Internet 32. The vocal softswitch 22, the ITSP voice gateway 24 and the ITSP voice switch 28 are selected and configured by the ITSP to optimize VoIP product delivery. Similarly, the ITSP ATM/IP network 26 is configured and maintained by the ITSP.

To provision their VoIP products, a customer is provided with a provisioning device 14, for example an ATA device, suitably configured for the ITSP's VoIP architecture 10. The provisioning device 14 is typically provided by the reseller via the ITSP who incorporates the provisioning device 14 in the ITSP VoIP architecture 10 via the ITSP's equipment configuration files. A suitable provisioning device 14 may also be supplied by the customer provided that it is approved for use by the ITSP and is incorporated in the ITSP VoIP network via the ITSP's equipment configuration files. In a preferred embodiment, the reseller enters data related to the customer's provisioning device 14 when provisioning the VoIP products. The provisioning device 14 is configured using ITSP specific parameters that include a unique identifier, herein referred to as a SIP User ID, or an IS #, associated with a particular customer. The provisioning device 14 is typically co-located with the customer PSTN phone 12 to convert public switched network phone (PSTN) signals into digital packets suitable for transmission via the Internet and the ITSP ATM/IP network 26, and vice versa. However, other provisioning device location configurations are possible.

Thus, with provisioned VoIP products, a customer having the PSTN phone 12, the provisioning device 14, and the broadband modem 16 linked to the Internet 32, can place calls to any PSTN phone in the world at a cost savings. Similarly, a call from any PSTN phone in the world can be routed via the ITSP system 18 to the customer PSTN phone 12 and may result in a cost savings to the calling party. For example, if the provisioned VoIP telephony products purchased by the customer include one or more direct inward dialing (DID) numbers, for example a Florida DID number, a person placing a call from within Florida can dial the Florida DID number associated with the customer, and be connected to the customer even if the customer (and his/her ATA device) is on another continent (e.g., Australia). Thus, a business may purchase multiple DID numbers associated with different locales to relieve their business customers of the burden of having to dial long distance and/or overseas phone numbers to reach them, for example.

In addition, because a properly configured provisioning device 14 is portable and recognizable by the ITSP's IP network (via an ITSP configuration file), a customer may easily move their provisioned VoIP service to another location. For example, a customer and his/her ATA device may relocate from Virginia to Chicago. A new IP address assigned to the relocated ATA device by the customer's local ISP is correlated to the customer's IS# by the ITSP vocal softswitch 22. As a result, a calling party in Virginia may not be aware that the customer has relocated from Virginia to Chicago. Further, the calling party may avoid charges typically associated with a long distance phone call.

Briefly, during operation the provisioning device 14 converts calling party PSTN dial tone signals, received from the customer PSTN phone 12 into digital packets (or datagrams). The digital packets are routed via the Internet 32 and the ITSP ATM/IP network 26 to the vocal softswitch 22. Upon receipt of the digital packets, the vocal softswitch 22, using a series of look-up tables, identifies the provisioning device 14 and acknowledges digital packet receipt to the provisioning device 14. In addition, the vocal softswitch 22 determines the best route, via the ITSP ATM/IP network 26, to the called party PSTN phone 20. Call set-up, routing and authentication are enabled using the session initiation protocol (SIP). Subsequent voice signals from the customer PSTN phone 12 are digitized and routed through the Internet 32 and the ITSP ATM/AP network 26 to the ITSP voice gateway 24, where they are converted from Transmission Control Protocol/Internet Protocol (TCP/IP) to time division multiplexed (TDM) signals suitable for receipt by the ITSP voice switch 28. The TDM signals are switched and routed by the ITSP voice switch 28 through the PSTN 30 to the called party phone 20. If applicable to the calling party, telephone usage charges are incurred only as a result of the “last mile” from the local class 5 end office switch on the PSTN 30 to the called party PSTN phone 20. Therefore, significant cost saving can be realized for any globally originated VoIP call on both inter and intra country calling because a significant portion of the call is transmitted via the Internet 32 and the ITSP ATM/AP network 26, rather than over the PSTN 30.

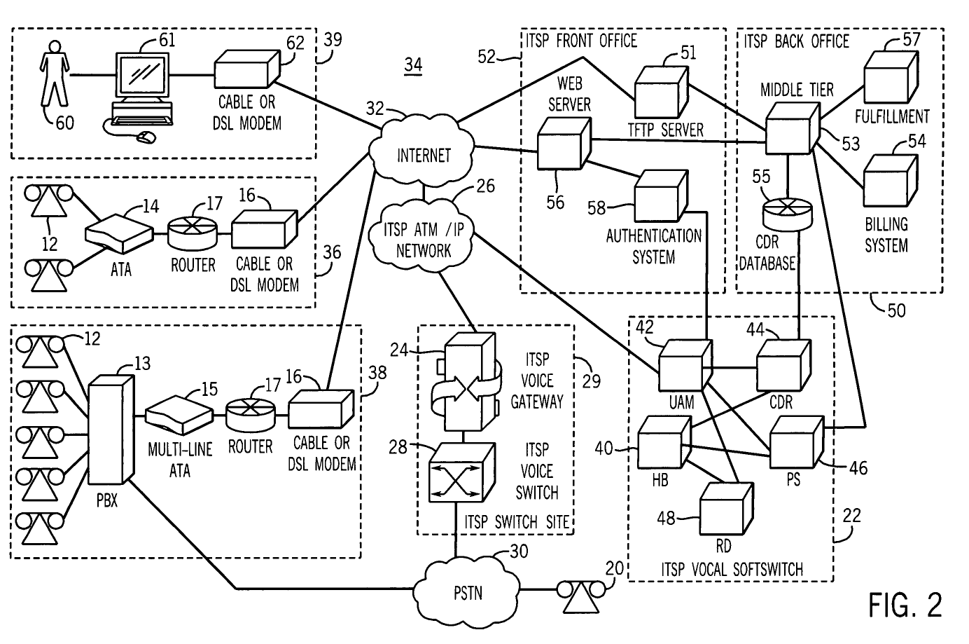

FIG. 2 is another block diagram of the SIP based VoIP architecture 34 that incorporates the VoIP architecture 10 in FIG. 1 and additionally includes customer configurations 36 and 38, and a reseller configuration 39. An ISTP front office 52 and back office 50 are also included in the SIP based VoIP architecture 34. In the illustrated example of FIG. 2, the ITSP voice gateway 24 and the ITSP voice switch 28 are preferably co-located at an ITSP switch site 29; however, other configurations are contemplated.

The reseller configuration 39 includes the reseller 60 and his/her PC 61 coupled to the Internet 32 via a cable, DSL or other broadband modem 62. Although coupled via a cable or modem, it is contemplated that the reseller may have access to the Internet via a wireless device such as a PDA or a wireless telephone. It is also contemplated that the access may include other wireless links such as a satellite link.

Each of the customer configurations 36 and 38 represent one customer equipment configuration that may be utilized to place VoIP calls. Customer configuration 36, representing a business or retail customer, includes two customer PSTN phones 12 coupled to a provisioning device 14 coupled to a cable or DSL broadband modem 16 via an optional router 17. Similarly, customer configuration 38 representing a business or call shop customer, includes five customer PSTN phones 12 coupled to a private branch exchange 13 (PBX). More or less PSTN phones 12 may be utilized depending on the size of the business. The PBX 13 is coupled directly to the PSTN 30 and to a multi-line provisioning device 15. The multi-line provisioning device 15 is adapted to convert PSTN signals from the five PSTN phones 12 into digital packets suitable for transmission via the Internet. The multi-line provisioning device 15 is coupled to a cable or DSL broadband modem 16 via an optional router 17. Although coupled via a cable or modem, it is contemplated that the link to the Internet may further include a radio frequency link using one of a variety of technologies such as Wireless Fidelity (“Wi-Fi”), Bluetooth™, code division multiple access (“CDMA”), global system for mobile communications (“GSM”), etc.

The ITSP vocal softswitch 22 is preferably configured with five servers, the heartbeat server (HB) 40, the user agent marshall server (UAM) 42, the call detail records CDR server (CDR) 44, the provisioning server (PS) 46, and the Redirect server (RD) 48, having specific functionality as described below, however other server configurations are contemplated. The UAM 42 is responsible for user authentication, message translation and collection of detailed billing, the RD 48 is responsible for routing choices, the PS 46 is responsible for maintaining information about end users, the various ITSP servers, the dial plans and the overall system configuration, the CDR 44 receives and stores call detail records, and the HB 40 is responsible for monitoring the other servers of the ITSP vocal softswitch 22. In addition, the CDR 44 is coupled to the ITSP back office 50 for billing purposes.

The ITSP Back Office 50 includes a middle tier server 53, a billing system server 54 coupled to the middle tier server 53, and a CDR database 55 coupled to the middle tier server 53 and the CDR 44. The middle tier server 53 is also coupled to the PS 46. A fulfillment server 57 is also included in the ITSP back office 50 and is coupled to the middle tier server 53 to log/ship/track provisioning devices sold to the resellers. Alternatively, an outside vendor (e.g., United Parcel Service (“UPS”)) may be utilized to accomplish the log/ship/track function.

The ITSP front office 52 includes a web sever 56 coupled to an authentication system 58 and the Internet 32. Also included is a trivial file transfer protocol (TFTP) server 51 coupled between the Internet 32 and the middle tier server 53 to “hold” and transfer configuration files requested by the provisioning device 14 or the multi-line provisioning device 15. As described below, the web server 56 provides the web pages required for the online reseller management tool and the online customer tool (i.e., the reseller's browser retrieves the web pages from the web server 56). The web server 56 is also coupled to the middle tier server 53. Upon request by the web server 56, the middle tier server 53, among other things, retrieves data and/or information from the back office systems (e.g., the billing system 54, the CDR database 55) used to populate the web pages of an online reseller management tool and an online customer tool (discussed below). A remotely located reseller 60 (or reseller's customer) having a personal computer (PC), a personal digital assistant (PDA), a suitably configured cellular phone, etc., with Internet access, may therefore access the online reseller management tool and the online customer tool via their personal computer 61.

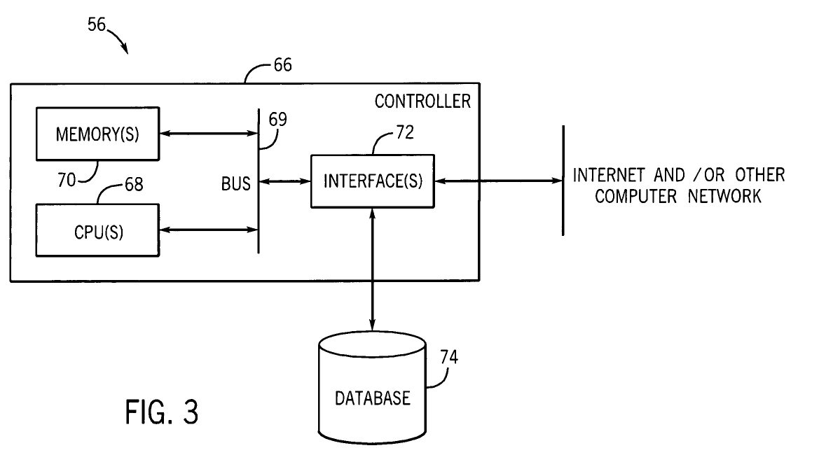

FIG. 3 is a partial block diagram of a number of components that may be incorporated in the web server 56. The web server 56 includes a controller 66 which preferably has a central processing unit (CPU) 68 electrically coupled by an address/data bus 69 to a memory device(s) 70 and a network interface circuit 72. The CPU 68 may be any type of well known CPU, such as an Intel Pentium™ processor. The memory device(s) 70 preferably includes volatile and non-volatile memory, and stores one or more software programs that implement all or part of the methods described below. The memory device(s) 70 may also store web page data, web page code, purchase requests, usernames, passwords, and other data. The software programs(s) may be executed in the CPU 68 in a well known manner. However, some of the steps described in the method below may be performed manually or without the use of the web server 56. The memory device 70 and/or a separate database 74 may also store files, programs, web pages, etc. for use by the middle tier server 53, the authentication system 58 and remotely located computers such as the PC 61 of the reseller configuration 39. The network interface circuit 72 may be implemented using any data transceiver, such as an Ethernet transceiver. Further, the network 74 may be any type of network, such as a local area network (LAN) and/or the Internet.

Although not separately illustrated, for purposes of receiving web page requests, purchase requests, CDR requests, usernames, password, information, and other data, the web server 56 may include a network receiver (e.g., an Ethernet interface circuit electrically coupled to the Internet via an Ethernet cable) operatively coupled to the Internet 32 and various computers/servers of the SIP based VoIP architecture 34 in a well known manner. Similarly, for purposes of transmitting web pages, reseller and customer information, billing information, CDR information, and other data, the web server 56 may include a network transmitter (e.g., an Ethernet interface circuit electrically coupled to the Internet via an Ethernet cable) operatively coupled to the Internet 32 and various computers/servers of the SIP based VoIP architecture 34 in a well known manner. The web server 56 may also include a database interface to enable sending to and retrieving data from the database 74, an authorization module for receiving and authorizing user names and/or passwords associated with registered resellers and customers, and one or more management modules for controlling overall operation of the web server 56. In addition, other servers of the SIP based VoIP architecture 34 may be similarly configured.

It should be appreciated that although the illustrated controller 66 is a preferable implementation of the present invention, the present invention may also include implementation via one or more application specific integrated circuits (ASICs), field programmable gate arrays (FPGA), adaptable computing integrated circuits, one or more hardwired devices, or one or more mechanical devices.

One manner in which the web server 56 may operate is described below in connection with one or more flowchart(s) that represents a number of portions or routines of one or more computer programs, which may be stored in one or more of the memory devices 70 of the controller 66. The computer program(s) or portions thereof may also be stored remotely, outside of the web server 56 and may therefore control the operation from a remote location.

As mentioned above, a method and system is described herein where an ITSP sells the VoIP telephony products to resellers, and where the resellers provision the VoIP products (via an online tool) and then “resells” the provisioned VoIP products to a customer. The method and system is also described herein where the ITSP sells provisioned VoIP telephony products via an online customer management tool directly to end customers. The VoIP products and ITSP provided provisioning devices are preferably “pre-paid” but “line-of-credit” transactions are contemplated. The method may include one or more of (1) defining a number of VoIP products using preselected VoIP product parameters, (2) providing electronic access to the VoIP products to registered resellers via an online reseller management tool and/or to end customers via an online customer management tool, (3) enabling provisioning of the VoIP products when the VoIP products are purchased via the online reseller management tool and/or the online customer management tool, and (4) providing an additional online customer tool to the resellers and the customers to check the status of calling activity associated with the purchased VoIP products. The method and system further includes (5) providing an ITSP administration tool. The ITSP administration tool enables the ITSP to manage financial functions associated with, for example, reseller purchases of the plurality of VoIP products. Additionally, the method and system includes (6) providing a technical support scheme to ITSP resellers and customers to remedy technical problems associated with their purchased VoIP products.

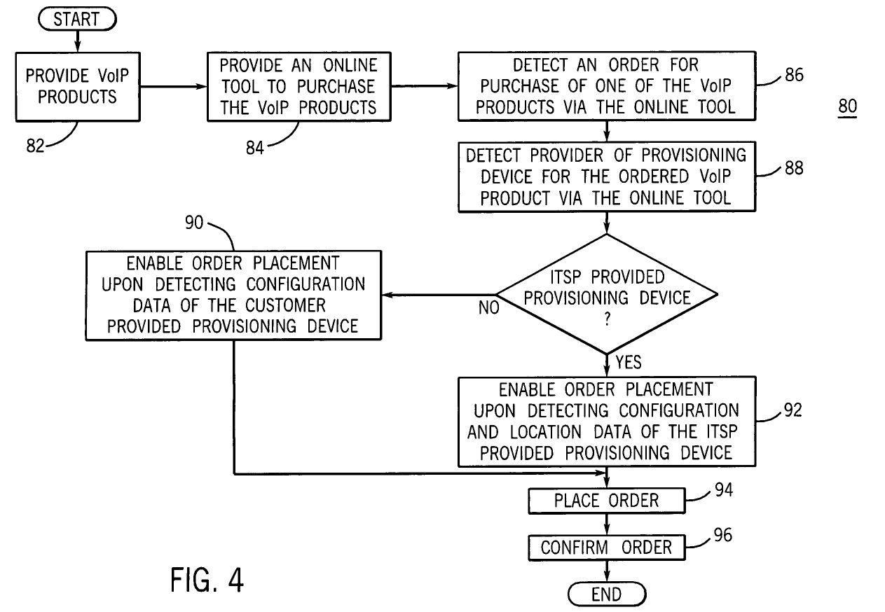

FIG. 4 is a flowchart of a method 80 for providing VoIP products according to an embodiment of the disclosed invention. Referring to FIG. 4, a plurality of VoIP products are provided (step 82). As discussed below, the VoIP products may be defined by the ITSP for purchase by a reseller or by an end customer. An online tool to access, provision and purchase the VoIP products, is also provided (step 84). Selection of one or more of the VoIP products by a reseller or an end customer, via their PC and browser, is therefore enabled via the online tool.

First, the controller 66 detects selection of a VoIP product by a purchaser using the online tool (step 86). Because each of the VoIP products requires provisioning via a provisioning device (e.g., the ATA 14), the purchaser must indicate whether the ITSP or the purchaser/purchaser's customer will provide the necessary provisioning device for the selected VoIP product. The purchaser indicates the provisioning device provider via the online tool. Therefore, after detection of selection of a VoIP product, the controller 66 detects the provisioning device provider for the selected VoIP product (step 88). In addition to identifying the provisioning device provider, provisioning includes configuring the provisioning device(s).

If the purchaser indicates that the provisioning device provider is the purchaser/purchaser's customer, then the controller 66 will enable order placement upon detecting a type Media Access Control (“MAC”) address and serial number of the customer provided device (step 90). If the purchaser indicates that the provisioning device provider is the ITSP, then the controller 66 will enable order placement upon detecting a type selection and a location configuration (e.g., behind a firewall, network address translation, DID number) of the ITSP provided provisioning device (step 92). If the purchaser is a reseller, then he/she selects the provisioning device for the selected VoIP product on behalf of the end customer.

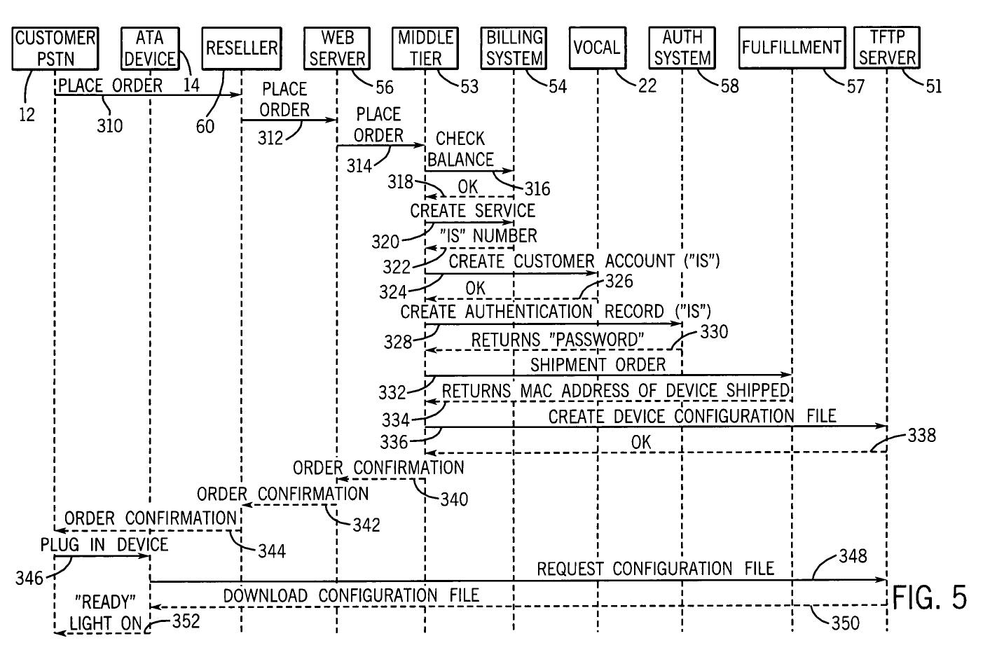

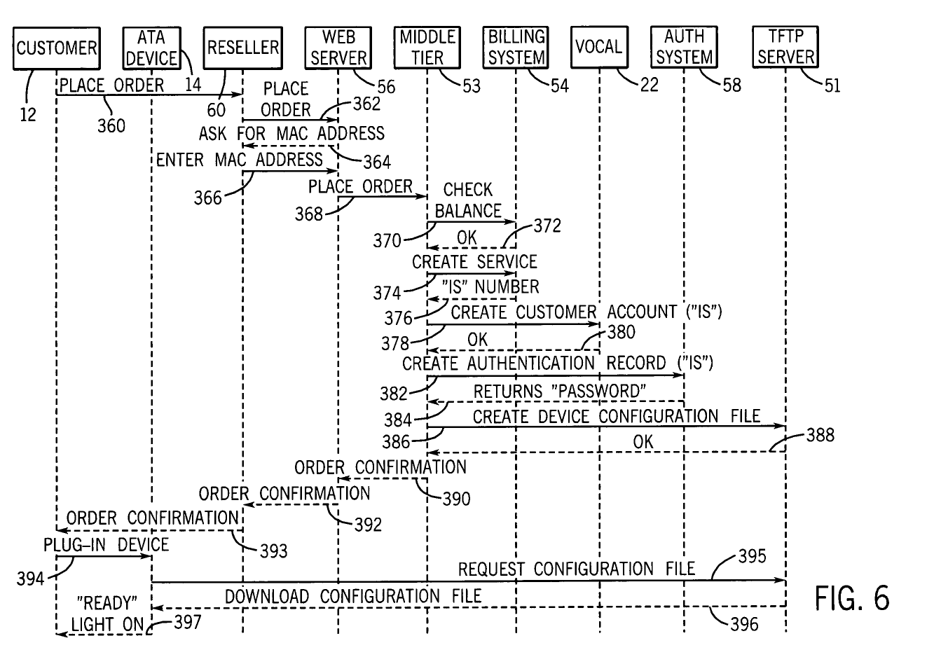

In addition to provisioning device selection, provisioning also includes, for example, generating reseller/end customer numbers and accounts, shipping provisioning devices, creating an associated device configuration file, and populating ITSP servers with the necessary configuration information. For example, FIG. 5 is an exemplary sequence diagram for provisioning the VoIP products with associated provisioning devices provided by the ITSP. FIG. 6 is an exemplary sequence diagram for provisioning the VoIP with associated provisioning devices provided by the end customer. As illustrated in FIGS. 5 and 6, upon receiving an “order” for VoIP product(s) from the reseller, the web server 56 transmits the order to the middle tier server 53, where accounts, records and other information required for provisioning are generated. Although preformed by the middle tier server 53, it is contemplated that other servers may be used to generate accounts, records and other information required for provisioning.

Referring again to FIG. 4, when the necessary information has been detected in the appropriate fields of pages transmitted and displayed via the online tool by the reseller or the end customer, the order is placed (step 94). When provisioning is completed, an “order confirmation” indication is transmitted to the reseller or the end customer (step 96). In addition, when activated (i.e., plugged-in), the provisional device 14 requests and receives its configuration file, thereby allowing the end customer to utilize his/her provisioned VoIP product.

Referring to FIG. 5 in more detail, upon receipt of an order request from a customer (step 310), a reseller 60, using his/her personal computer and browser, accesses an online reseller management tool hosted by the web server 56. Utilizing the various web pages transmitted via the reseller's browser (described below), the reseller 60 places an order for a VoIP product (step 312). The order for the VoIP product is transmitted to the middle tier server 53 (step 314). Upon receipt of the order, the middle tier server 53 executes a number of steps to provision the order in the SIP based VoIP architecture 34. First, the middle tier server 53, in communication with the billing system 54, verifies the resellers account balance (steps 316, 318) and requests service initiation and receives an IS # (steps 320, 322). Second, the middle tier server 53 in communication with the vocal softswitch 22 creates a customer account (step 324) and transmits the information to the vocal softswitch 22. The customer account is identified by the IS # and is associated with the customer.

Next, in response to receipt of an acknowledgement by the vocal softswitch 22 (step 326), the middle tier server 53, in communication with the authentication system 58, creates an authentication record associated with the IS # (step 328). The authentication system 58 responds with a password associated with the IS # (step 330). The middle tier server 53, in communication with the fulfillment server 57, requests that the fulfillment server 57 deliver the ITSP provided provisioning device to the customer (step 332). In response, the fulfillment server 57 provides the MAC address of the shipped provisioning device to the middle tier server 53 (step 334). The middle tier service 53 then creates a device configuration file and communicates it to the TFTP server 51 (step 336). In response to an acknowledgement from the TFTP server 51 (step 338), the order is confirmed to the reseller 60 via the web server 56 (step 340, step 342). Upon receipt and installation of the device 14 to the customer PSTN phone 12, the provisioning device identifies itself to the TFTP server 51 (via the IS #) and requests that its configuration file be downloaded (step 348) from the TFTP server 51. Upon receipt of the configuration file (step 350) the provisioning device indicates a ready state (step 352) and VoIP phone calls may be placed and received via the customer PSTN phone 12.

Referring to FIG. 6 in more detail, upon receipt of an order request from a customer (step 360), a reseller 60, using his/her personal computer and browser, accesses the online reseller management tool hosted by the web server 56. Utilizing the various web pages (described below), the reseller 60 places an order for a VoIP product (step 362) which is transmitted to the web server 56 (step 362). The reseller also indicates that the customer will be providing his/her own provisioning device to provision the VoIP product. In response, the web server 56 requests and receives information regarding the customer provided provisioning device, for example, the MAC address of a customer provided provisioning device 14 (step 364, step 366). Upon receipt of the requested provisioning device information, the web server 56 transmits the order to the middle tier 53 (step 368). The middle tier server 53 then executes a number of steps to further provision the order in the SIP based VoIP architecture 34. First, the middle tier server 53, in communication with the billing system 54, verifies the resellers account balance (steps 370, 372), and requests and receives an IS # (steps 374, step 376)). Second, the middle tier server 53 in communication with the vocal softswitch 22 creates a customer account (step 378) and transmits the information to the vocal softswitch 22.

In response to receipt of an acknowledgement by the vocal softswitch 22 (step 380), the middle tier server 53, in communication with the authentication system 58, creates an authentication record associated with the IS # (step 382). The authentication system 58 responds with a password associated with the IS # (step 384). The middle tier server 53 then creates a device configuration file and communicates it to the TFTP server 51 (step 386). In response to an acknowledgement from the TFTP server 51 (step 388), the order is confirmed to the reseller 60 via the web server 56 (step 390, step 392). Upon installation of the provisioning device to the customer PSTN phone 12, the device 14 identifies itself to the TFTP server 51 (via the IS #) and requests that its configuration file be downloaded (step 395). Upon receipt of the configuration file (step 396) the provisioning device indicates a ready state (step 397) and VoIP phone calls may be placed from the customer PSTN phone 12.

(1) Defining a Plurality of VoIP Telephony Products Using Preselected VoIP Product Parameters

Preselected VoIP telephony parameters associated with the VoIP telephony products may include International VoIP Reseller rates, shipping fees for provisioning device(s) (e.g., ATA devices, SIP phones, multi-line gateways, etc.), fees such as activation fees, service fees, DID fees, taxes, to name a few. The ITSP, using its business model information, market conditions, cost information, equipment availability, etc., can “package” the VoIP products in any number of arrangements, depending on the desired parameters.

(2) Providing Electronic Access to Purchase the Plurality of VoIP Products

In an embodiment of the disclosed invention, the resellers are provided access to an online reseller management tool. The online reseller management tool enables the reseller to order VoIP products and manage customer accounts of his/her customers purchasing the VoIP products from the reseller. Referring again to FIG. 2, when a reseller 60 desires to access the online reseller management tool, he/she logs onto the PC 61, opens a browser window (e.g., Microsoft Internet Explorer™), and enters the URL (resolves to TCP/IP) associated with the online reseller management tool. In the illustrated example, the online reseller management tool is hosted by the web server 56 although it may also be hosted by one of any number of other ITSP provided servers of the SIP based VoIP architecture 34. The web pages associated with the online reseller management tool are then selectively provided to the reseller's 60 browser as described above. Data required to populate selected web pages of the online reseller management tool is forwarded, upon request by the web server 56, from the middle tier 53 (retrieving from the billing systems 54, the CDR database 55 and other back office systems).

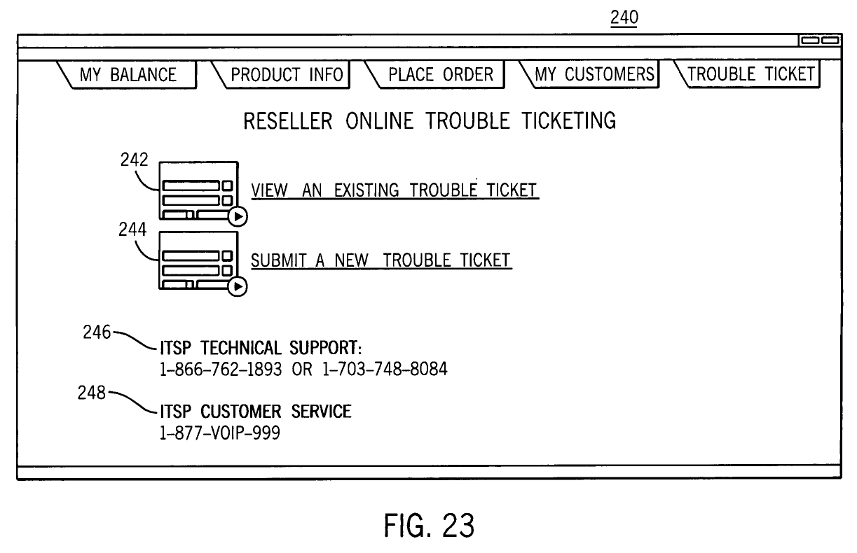

For example, the web server 56 does not keep a current list of which DID countries and cities are available for use. Instead, upon request by the web server 56, the DID countries and cities available for use by a reseller are retrieved from a database of the billing system 54. Similarly, when the reseller 60 places an order for VoIP products via the online reseller management tool, the web server 56 forwards the reseller's order information to the middle tier 53 which then processes it. These processes may include, for example, checking the reseller's credit or balance, creating a new service record in the billing system 54 to show a new customer account, creating a new service record in the vocal softswitch 22 so that customer calls can be properly processed, forwarding a message to a service delivery department of the ITSP to ship VoIP provisioning devices 14 to the reseller 60, creating a device configuration file (see, FIGS. 24a and 24b) and make it available on a file server (e.g., the TFTP server) of the ITSP, forward a summary of the order back to the reseller 60, to name a few. Data resulting from the order may again be forwarded to other servers or databases associated with the billing system 54.

Similarly, in another embodiment, end customers may be provided with access to an online customer management tool that is configured to operate in a similar fashion to the online reseller management tool.

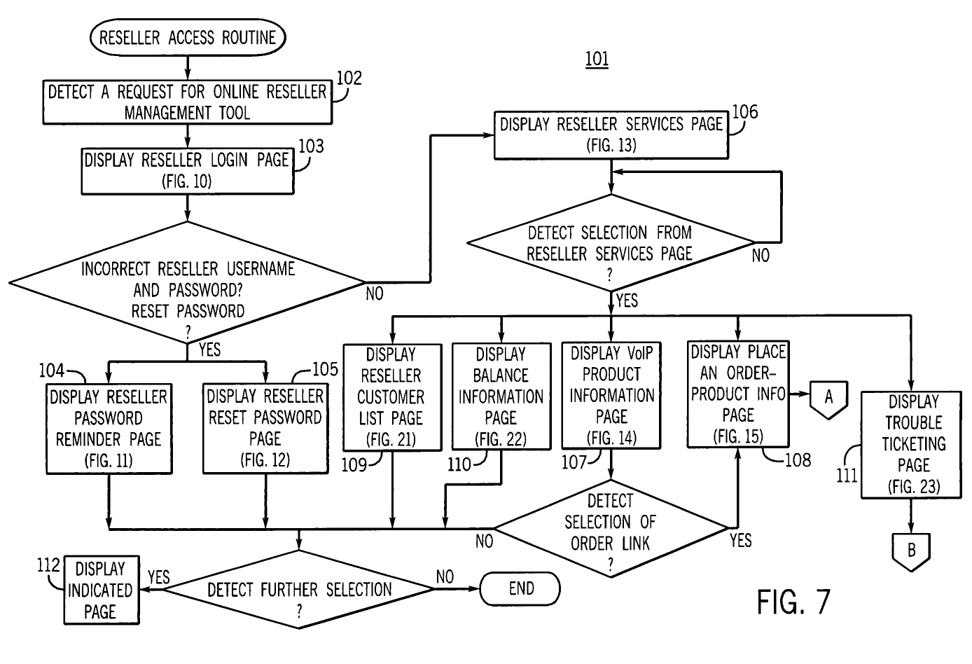

FIGS. 7-9 are a series of flowcharts of a reseller access routine 101 for providing a VoIP product(s) via an online reseller management tool provided by the ITSP using the SIP based VoIP architecture of FIG. 2. Referring to FIG. 7, the reseller access routine 101 begins when the controller 66 detects a request for the online reseller management tool (step 102) and a reseller login page of the online reseller management tool is displayed (step 103). The reseller login page allows the reseller to gain access to a services page of the online reseller management tool, upon proper login.

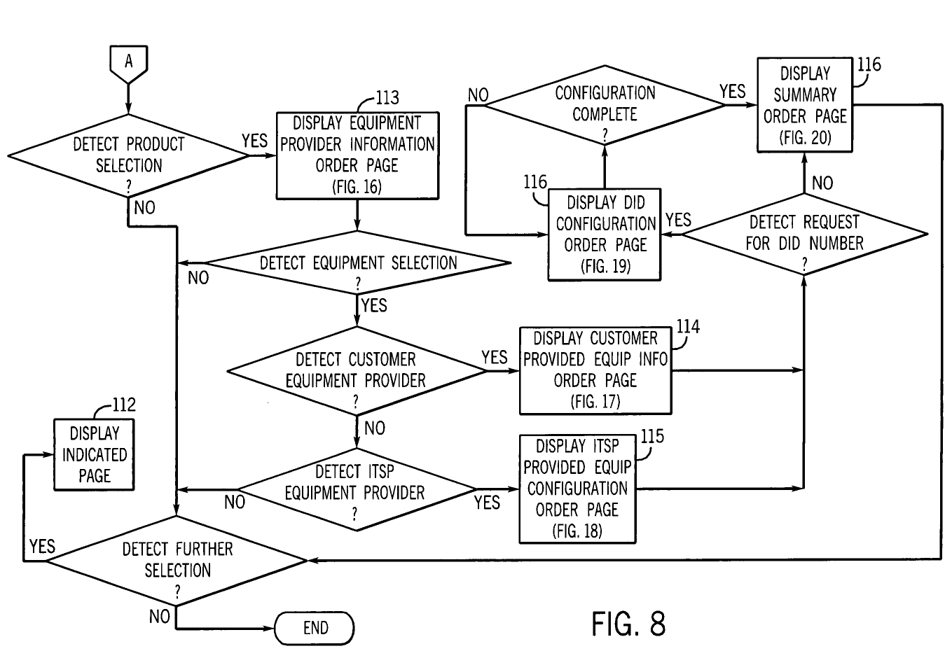

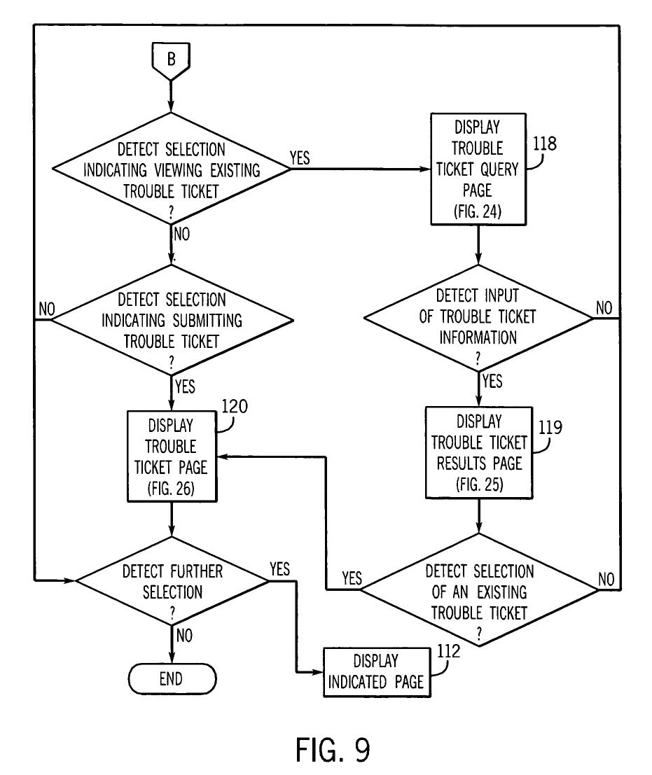

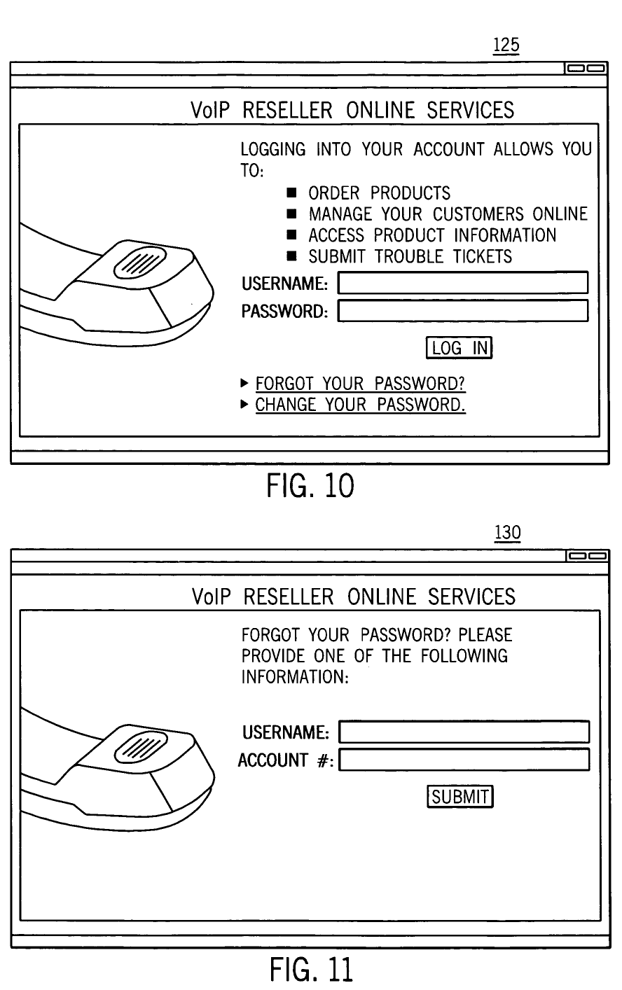

For example, FIG. 10 is screen shot of an exemplary reseller login page 125 of the online reseller management tool. As shown in FIG. 10, for security reasons, the reseller is prompted for a username and a password. If the reseller forgets his/her password, a reseller password reminder page is displayed to enable the reseller to request access to their account in the online reseller management tool (step 104). FIG. 11 is screen shot of an exemplary reseller password reminder page 130 of the online reseller management tool enabling the reseller to access their password (received via email) upon entering his/her username and account number. Similarly, FIG. 12 is screen shot of an exemplary reseller password reset page 135 of the online reseller management tool enabling the reseller to reset his/her password (step 105).

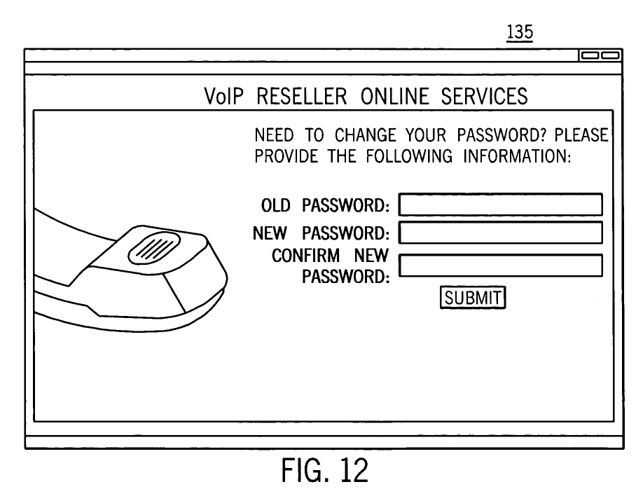

Upon detecting successful entry of the reseller's user name and password, the controller 66 enables reseller access to a displayed reseller service selection page (step 106). The reseller services page preferably provides links to balance information, VoIP product information, order placement, customer tracking information, and trouble ticket submission and review. For example, FIG. 13 is screen shot of an exemplary services page 140 of the online reseller management tool enabling reseller selection of a service from among a plurality of listed services via web page links. As illustrated by FIG. 13, and although not exhaustive, the listed services may include viewing balance information via a “Balance Information” link 142, viewing product information via a “Product Information” link 144, placing an order via a “Place an Order” link 146, viewing customer information via a “Customer Information” link 148, and/or generating a trouble ticket via a “Trouble Ticket” link 149.

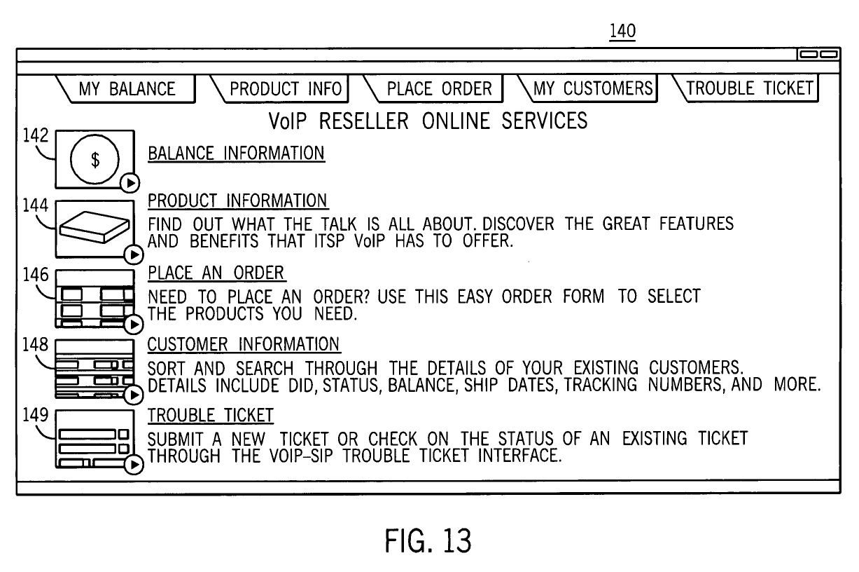

Referring again to FIG. 7, upon detecting selection of the Product Information link 144 from the services page 140, the controller 66 enables the reseller to access additional VoIP product information offered by the ITSP (step 107). For example, FIG. 14 is screen shot of an exemplary product information page 150 of the online reseller management tool enabling the reseller view VoIP product information. The product information page 150 preferably includes the name of the VoIP products 152 offered by the ITSP, a description 154 of the VoIP products, the U.S. dollar value 156 of the VoIP products, and an index that allows the reseller to reference a rate sheet applicable to a particular VoIP product. Links to other pages of the online reseller management tool are also displayed to the reseller.

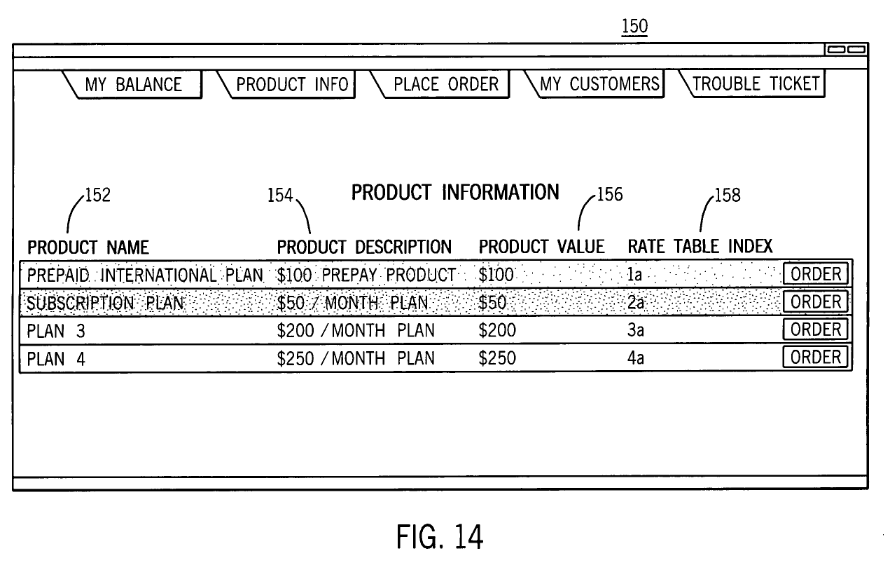

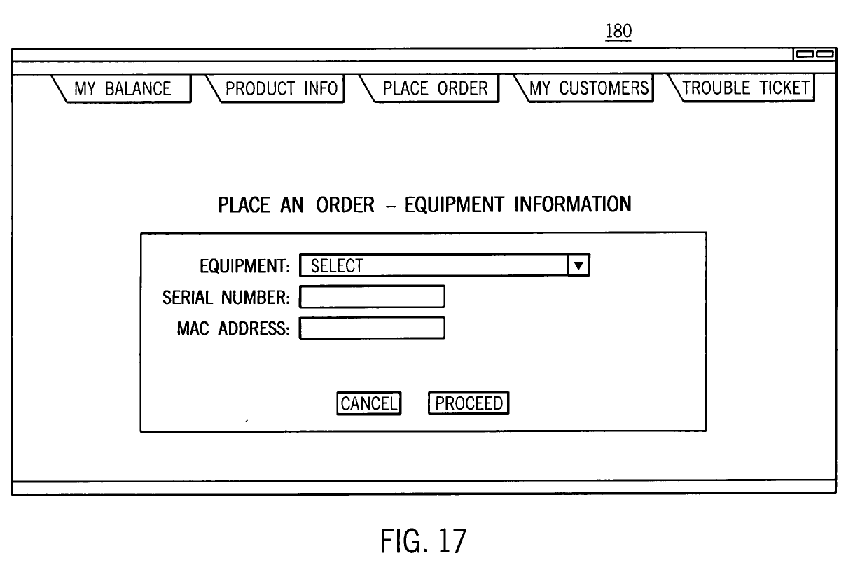

Referring again to FIGS. 7 and 13, upon detecting selection of the Place an Order link 146 from the reseller services page 140, the controller 66 sequentially displays a number of web pages that enable the reseller to select one or more VoIP product(s) from a list of VoIP products (steps 108-117). Upon detecting selection of a VoIP product from a product information order page, the controller 66, via the number of web pages described in connection with FIGS. 15-20, prompts the reseller to specify: (a) a quantity, (b) a customer premise equipment (CPE) type, or provisioning device type (because multiple versions of the ATA devices may be available to support voltage/pin configurations in other countries), and (c) one or more DIDs (d) answers to configuration questions such as whether the dynamic host configuration protocol (DHCP) is to be used to enable IP addressing. When the reseller has completed the order process, the controller 66 causes an internal check to be performed to verify that the reseller's VoIP product order does not exceed the reseller's available credit.

FIGS. 15-20 are a series of screen shots of exemplary order pages 160, 170, 180, 190, 200, and 210, of the online reseller management tool enabling the reseller to order VoIP products from the ITSP. The exemplary order pages 160, 170, 180 and 190 allow a reseller to select, provision and purchase a customized order using the online customer management tool. Upon selecting the Place an Order link 146 from the reseller services page 140, the controller 66 displays the exemplary product order page 160 (step 108). Referring to FIGS. 8 and 15, the exemplary product order page 160 includes a pull-down list of the various VoIP products. The list is populated, via information provided by the back office 50 and the web server 56, based on the resellers previously entered username and password. The exemplary product order page 160 may also be accessed via one of the “Order” links provided on the product information page 150.

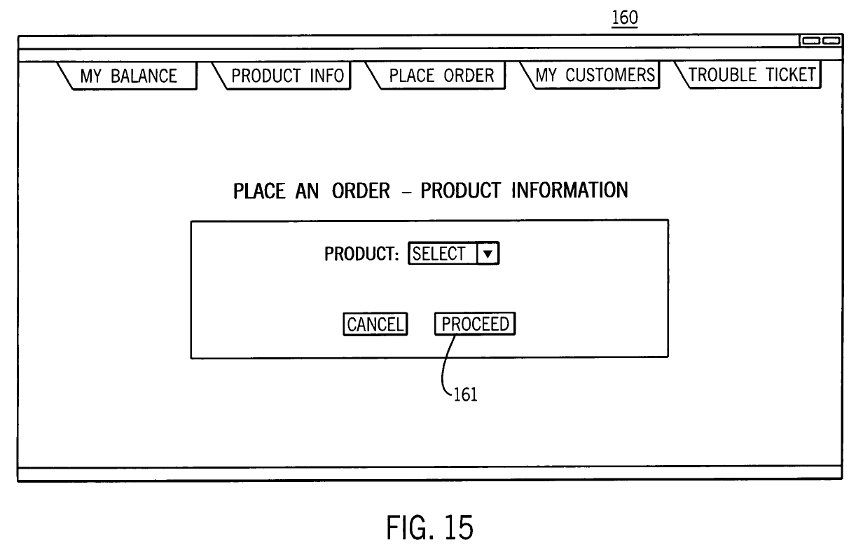

Upon selection of one of the VoIP products from the product order page 160, the reseller can proceed to the next step of the order process or cancel the order and return to the exemplary product information page 150. Upon detecting selection of a “Proceed” link 161 of the product order page 160, the controller 66 displays an equipment provider information order page 170 (step 113). As illustrated in FIG. 16, the exemplary equipment provider information order page 170 includes a pull-down list of various provisioning devices associated with the previously selected VoIP product. The exemplary equipment information order page 170 also requires the reseller to indicate (via selection) whether the provisioning devices associated with the selected VoIP product(s) will be provided by the ITSP or the reseller's end customer (see also, FIGS. 5 and 6).

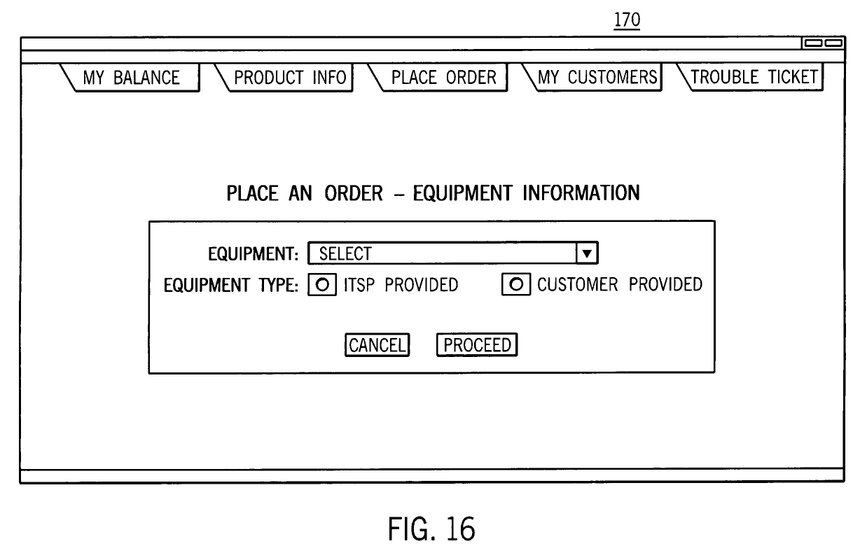

Based on the identity of the provisioning device provider supplied by the reseller, the controller 66 will display a configuration set-up page. As illustrated in FIG. 17, if the reseller selects the customer-provided option, the controller 66 displays the exemplary customer provided equipment information order page 180 (step 114). The reseller is then prompted to enter the type, the serial number and the media access control (MAC) address of the customer provided equipment in fields provided on the customer provided equipment information order page 180. (The MAC address is required before ITSP allows a reseller to activate the provisioning device). This ensures that the ITSP can certify the provisioning device and create a provisioning device configuration file that is subsequently utilized by the authentication system 58, the billing system 54, the vocal softswitch 22, and the servers and databases of the back office 50.

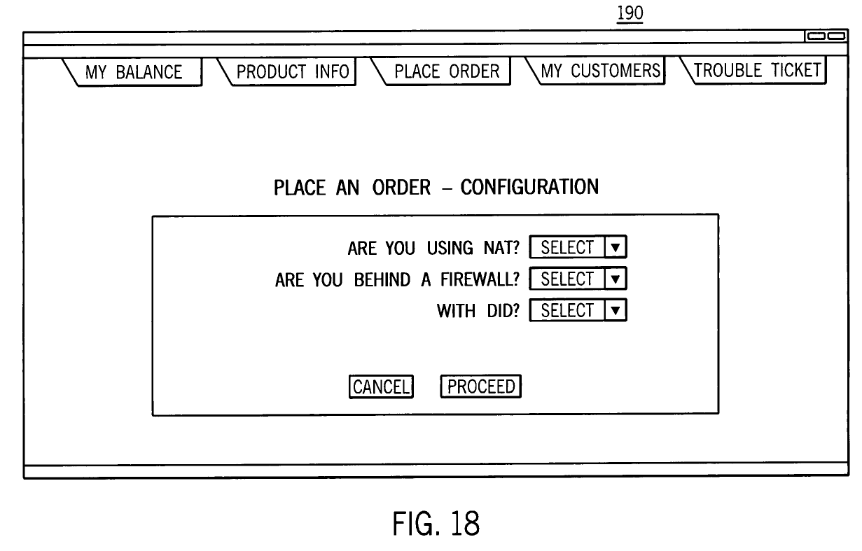

If the reseller selects the ITSP-provided option displayed on the equipment provider information order page 170, the controller 66 displays the exemplary ITSP configuration order page 190 illustrated in FIG. 19 (step 115). The reseller is prompted to answer a series of questions regarding the ordered provisioning device in fields provided on the ITSP configuration order page 190. For example, the reseller is asked whether the location of the equipment includes a network address translation (NAT), whether the provisioning device is to be placed “behind” a firewall, and whether one or more direct inward dialing (DID) numbers are to be added. The customer provided equipment information order page 180 and the ITSP configuration order page 190 also include links that allow the reseller to proceed to the next step of the order process or cancel and return to the equipment provider information order page 170.

If the reseller indicates via the configuration order page 190 that one or more DID numbers are to be added to the selected VoIP product(s), the controller 66 displays the exemplary DID configuration order page 200 (step 117). As illustrated by FIG. 19, the reseller is required to select a location for the provisioning device including the country, state (depending on the country selected), and the city. In addition, the reseller is provided with an option to select a location specific number. For example, within a city such as Melbourne, Australia, there are often several prefix digits to chose from (e.g., country code=61, city code=3). A link may also be provided on the DID configuration order page 200, which when selected, causes the controller 66 to display a listing of available DID numbers available for selection by the reseller. After detecting entry or the required DID information, the controller 66 may display summary text on the DID configuration order page 200 that indicates the resellers selected/assigned DID number(s) and the fees for the assigned DID numbers. The monthly fee is based on, for example, the location of the DID number.

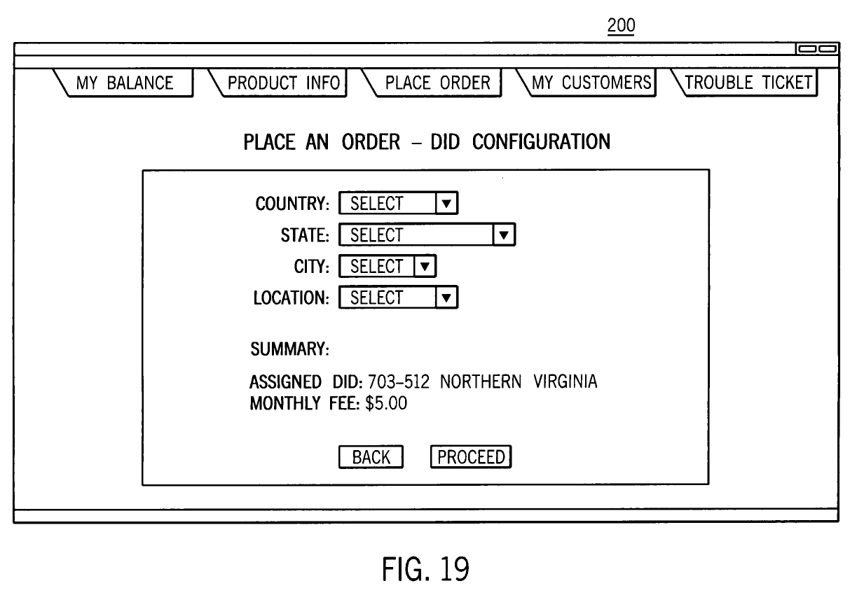

After detecting entry of the required DID information in the appropriate fields of the DID configuration order page 200, or detecting selection of “Proceed” links on either the equipment provider information order page 170 or the customer provided equipment information order page 180, the controller 66 displays a summary page (step 116). FIG. 20 is an exemplary summary order page 210. The reseller may also proceed to the next step of the order process or cancel and return to the exemplary configuration order page 190.

The exemplary order summary page 210 provides a detailed table of the resellers selection(s), and includes an order number, the provisioning device name, the provisioning device type, the product type, the dollar value, whether a DID number was purchased, the location number, whether the provisioning device is behind a firewall, and whether the provisioning device includes a NAT. The order summary page 210 also includes an edit and a delete button for each entry displayed, a total dollar amount charged for the reseller's current transaction, shipping charges and the reseller's available credit balance.

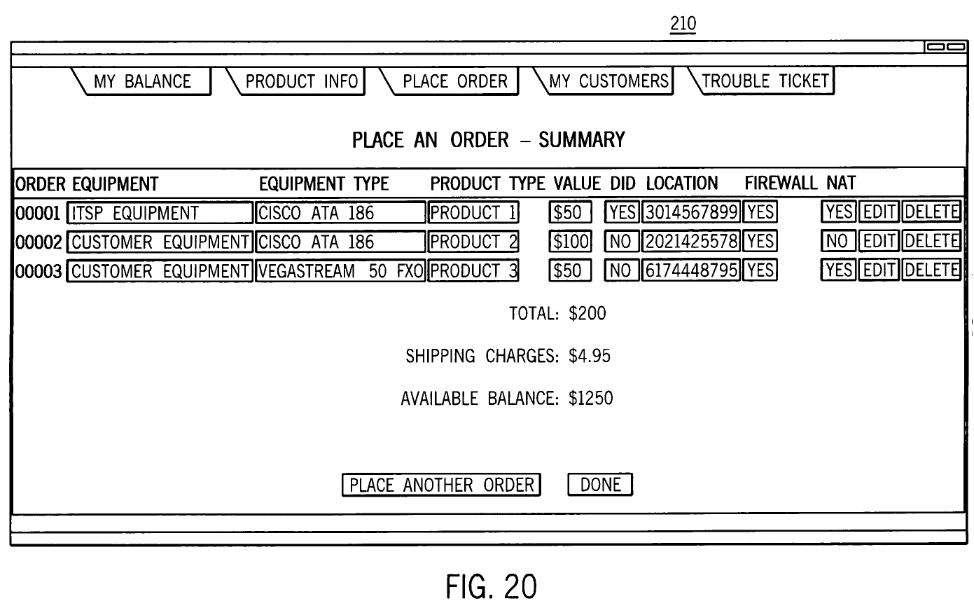

Referring again to FIGS. 7 and 13, upon detecting selection of the “Customer Information” link 148 on the reseller services page 140, the controller 66 displays (step 109) a reseller customer list page 220 to the reseller (see, FIG. 21). The reseller customer list page 220 allows the reseller to view a list of his/her existing customers, and to manage the associated customer accounts. The customer list preferably includes a list of customers 221 who have purchased provisioned VoIP telephony products from the reseller, as well as all other relevant customer information. The customer list may be sorted and/or searched by the reseller. For each listed customer 221, relevant customer information may include the current status 222 of the customer (e.g., active, suspended, cancelled), a username 223, a password 224, a serial number 225 of associated provisioning device, the MAC address 226 of the associated provisioning device, a UPS tracking number 227 for provisioning device delivery, an ITSP assigned SIP user identification number 228 (or IS#) associated with the provisioning devices, a DID number 229, a product type 230, the original price 231 of the products purchased by the customer, any outstanding balanced 232 owed the reseller, additional prepaid usage 233, date of purchase 234, a selectable call detail record (CDR) link 235 to access the customer's detailed call record, and a selectable TT link 236 to access the customer's trouble ticket information. A selectable Details link 237 is also included, which if selected by the reseller, enables the reseller to view customer details such as the customer's most recent log entry, trouble tickets associated with the customer, etc. Similarly, selection of the CDR link 235 enables the reseller to view a particular customer's CDRs for the previous thirty days, call details such as call end times, called number, inbound/outbound, call durations, rate for the destination, termination code, etc.

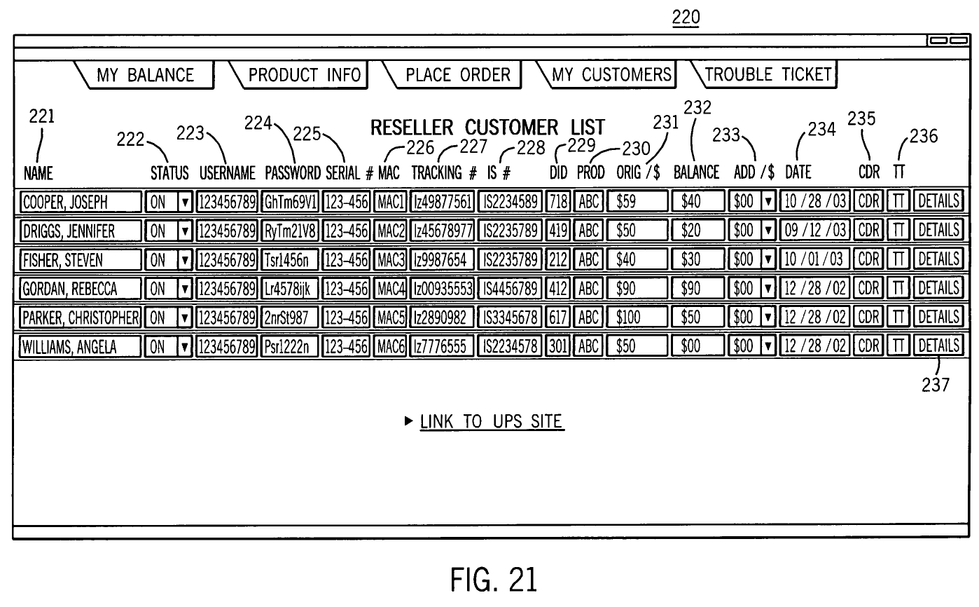

Referring again to FIGS. 7 and 13, upon detecting selection of the “Balance Information” link 142 on the reseller services page 140, the controller 66 displays a balance information page that enables the reseller to check his/her available credit balance and to link to a global collection site for further payment, if need be (step 110). FIG. 22 is an exemplary balance information page 238 that may be displayed by the controller 66. In addition to displaying the reseller's current balance, the exemplary balance information page 230 includes a “Pay Online” link 239 that allows the reseller to submit an online payment.

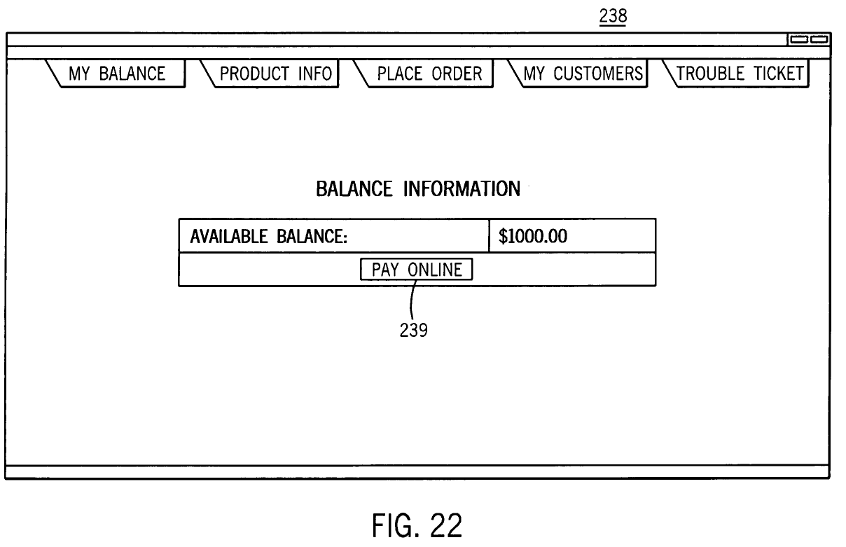

As mentioned in connection with FIGS. 7 and 21, the reseller may submit and view trouble tickets associated with the VoIP products purchased from the ITSP and provisioned VoIP products purchased by a customer from the reseller. Although the reseller is expected to provide first level support to his/her customers, the reseller is permitted to escalate the problem by submitting a trouble ticket to the ITSP via the online reseller management tool. Upon detecting selection of the “Trouble Ticket” link 149 on the reseller services page 140, the controller 66 displays a reseller online trouble ticketing page (step 111) that enables the reseller to either view an existing trouble ticket or generate a new one. FIG. 23 is an exemplary reseller online trouble ticketing page 240 that may be displayed by the controller 66 in response to reseller selection of the “Trouble ticket” link 149. The online trouble ticketing page 240 has two links; a “View” link 242 for viewing one or more existing trouble tickets and a “Submit” link 244 for submitting a new trouble ticket. ITSP technical support and customer service numbers 246, 248, are also provided on the exemplary reseller online trouble ticketing page 240.

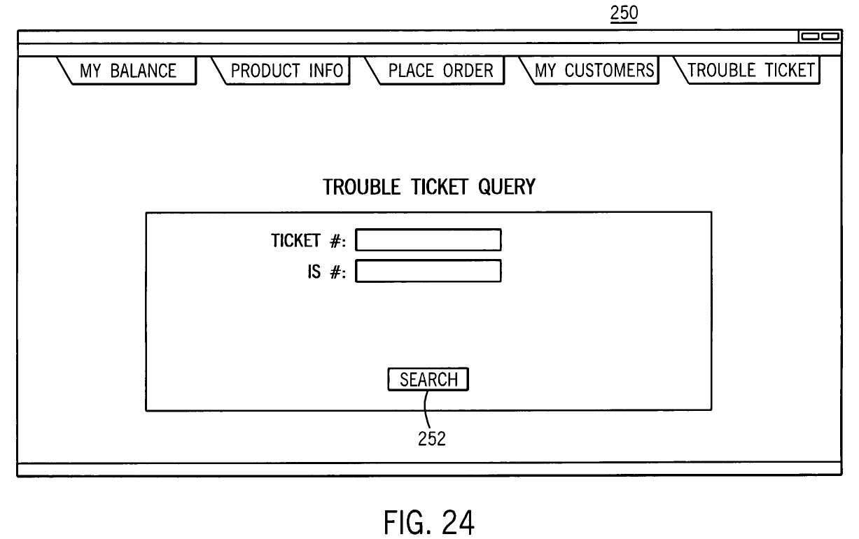

Referring to FIG. 11, upon detecting the View link 242, the controller 66 displays a trouble ticket query page (step 118). FIG. 24 is an exemplary trouble ticket query page 250 that may be displayed in response to reseller selection of the View link 242 on the trouble ticketing page 240. As illustrated by FIG. 24, the reseller is prompted to enter a trouble ticket number and an IS #, and then select a Search link 252 to complete the query. In response to detecting reseller selection of the Search link 252, the controller 66 will cause a trouble ticket results page to be displayed (step 119). FIG. 25 is an exemplary trouble ticket results page 260 that lists one or more selectable, trouble ticket profiles where each profile includes a ticket number 226, a ticket status 264, a date opened 266, and the SIP user ID 268 (a.k.a., an IS #). Reseller selection of one of the trouble ticket profiles will then cause the controller 66 to display the existing trouble ticket to the reseller (step 120).

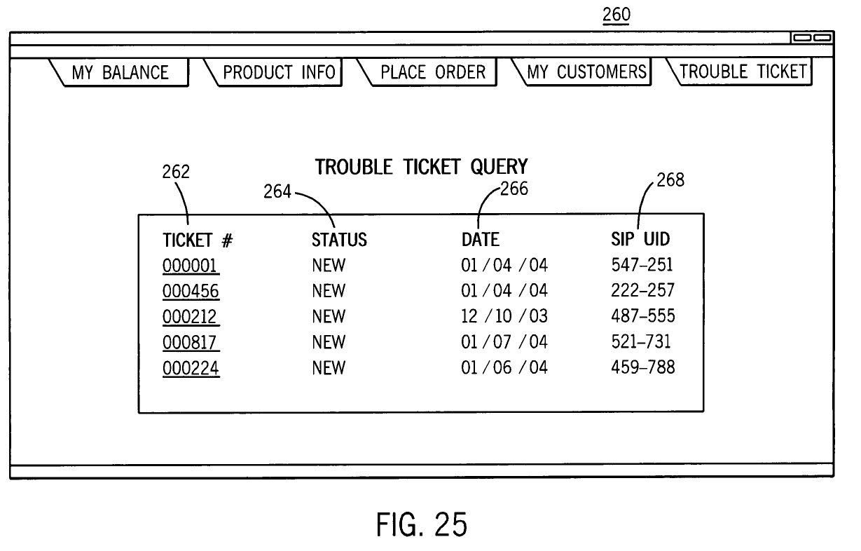

Referring again to FIG. 23, the reseller may submit a new trouble ticket via selection of the Submit link 244 of the reseller online trouble ticketing page 240. FIG. 26 an exemplary trouble ticket page 270 that may be displayed by the controller 66 in response to reseller selection of the Submit link 244 (or when requested via selection of a particular trouble ticket profile). The trouble ticket page 270 includes the trouble ticket number field, the status of the trouble ticket 271, a date opened field 272, an in-house development billing system (IDB) account number field 273 indicating the reseller, a company name indicating the reseller's company 274, the reseller's name field, the reseller's phone number field 276, the reseller's email field 277, a tech contact field 278, a tech contact's phone number field 279, a tech contact's email field 280. The aforementioned trouble ticket page 270 fields are automatically populated by the controller 66. The trouble ticket page 270 also includes a drop-down menu to select the problem 290, a drop-down menu to delineate the scope of the trouble 291, a drop-down menu to indicate the frequency of the problem 292, a called country name field indicating the country called when the trouble was experienced 293, a called number field indicating the telephone number that the customer called when the trouble was experienced 294, a comments field 295, a SIP user ID (UID) field 296 including a drop-down menu for selecting the customer's account ID. Additional fields including a SIP DID field indicating the customer's DID number after the SIP UID field has been populated, a CPE field indicating the type of customer premise equipment, a serial number field indicating the equipment's serial number, and a MAC address field indicating the equipment's MAC address, are automatically populated by the controller 66 based on other entered information. A resolution field and a cause of problem field included in the trouble ticket page 270 are completed by the ITSP technical support staff.

Although not specifically mentioned in connection with each of the above discussed screen shots or pages, it should be understood that the reseller can exit the reseller access routine 101 at any time using one of any well-known means (e.g., selecting the appropriate link, closing the browser).

Although illustrated using the exemplary screen shots described above, it is contemplated that the online reseller management tool may include more or less screen shots and/or may include different screen shots incorporating more or less fields and/or button links. Thus various embodiments of the online reseller management tool can be used in conjunction with the method and system for providing VoIP services to resellers

As mentioned above, in another embodiment, the ITSP may provide provisioned consumer VoIP products directly to customers. The customer, using an ITSP provided online customer management tool and his/her credit card, may select from one of a number of VoIP products, and provision the VoIP products to form provisioned VoIP products, much like a reseller. Like the online reseller management tool, the online customer management tool preferably includes web pages that enable the customer to view VoIP products, to view VoIP product details and rates, to prepay for VoIP products, to select between using ITSP provided provisioning device or using their own provisioning device to enter provisioning device configuration details to provision the VoIP products, etc. Like the online reseller management tool, the online customer management tool preferably includes an interactive web page allowing the customer to add value, or credit, to their existing account. Accordingly, the SIP based VoIP architecture of FIG. 2 may also include supplementary servers, databases, etc. (e.g., a softswitch configured with Broadsoft™ software) to accommodate the sale of provisioned VoIP products directly to customers.

(3) Enabling Provisioning of the Plurality of VoIP Telephony Products

As mentioned in connection with FIGS. 4-6 and 13-19, the method by which an ITSP sells VoIP products to resellers includes enabling provisioning of the VoIP products, including providing and/or configuring the provisioning device (e.g., dual line ATAs with or without routers, multi-line SIP gateways, SIP phones, etc.) used in conjunction with the VoIP products. Upon placing an order, the reseller is therefore required to indicate whether he/she wishes to purchase the provisioning device from the ITSP or whether the (resellers) customer will provide their own provisioning device. Accordingly, the ITSP maintains a list of approved equipment suitable for use in the SIP based VoIP architecture described in connection with FIGS. 1 and 2. The equipment list is made available to the reseller via the online reseller management tool described above. The ITSP also maintains equipment manuals associated with the approved equipment and further, makes the equipment manuals available to the reseller's customers via the online customer tool (discussed below).

(4) Providing an Online Customer Tool to the Plurality of Resellers

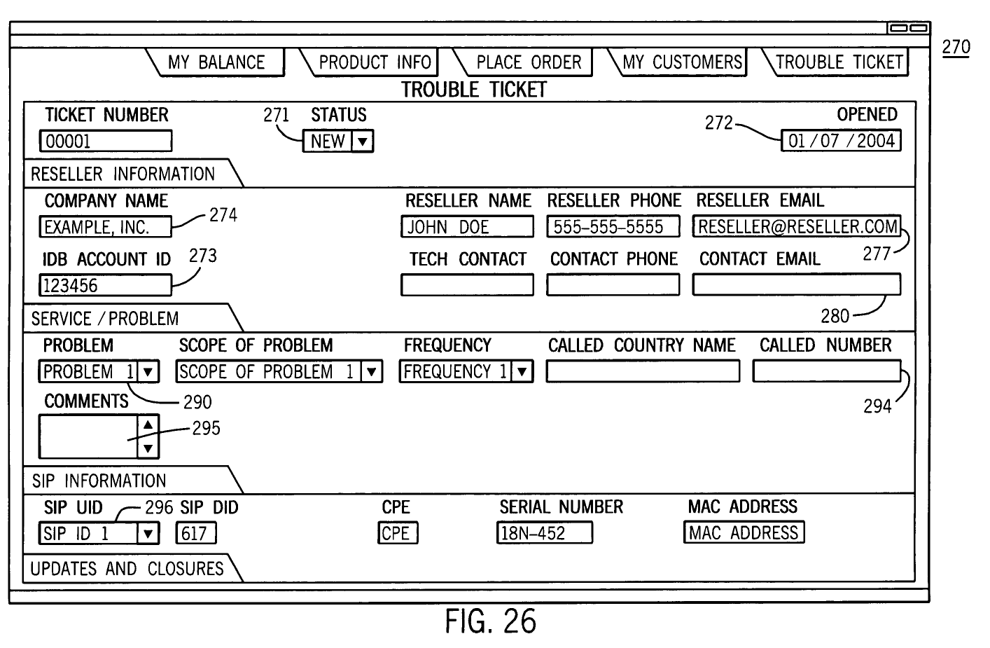

The customers of the resellers will preferably have access to an online customer tool to view information associated with their provisioned VoIP telephony products. FIG. 27 is a flowchart of a customer tool routine 401 for providing online customer access to information associated with their provisioned VoIP telephony products iaccording to an embodiment of the present invention. Referring to FIG. 27, the customer tool routine 401 begins when a request for access to the online customer tool is detected (step 402) and the customer login page is displayed (step 403). The customer login page requires the customer to enter their username and password to gain access to their call detail records. In addition, the customer login page also enables the customer to view installation guides associated with their provisioning device 14 (e.g., the ATA) and to view frequently asked questions (FAQs).

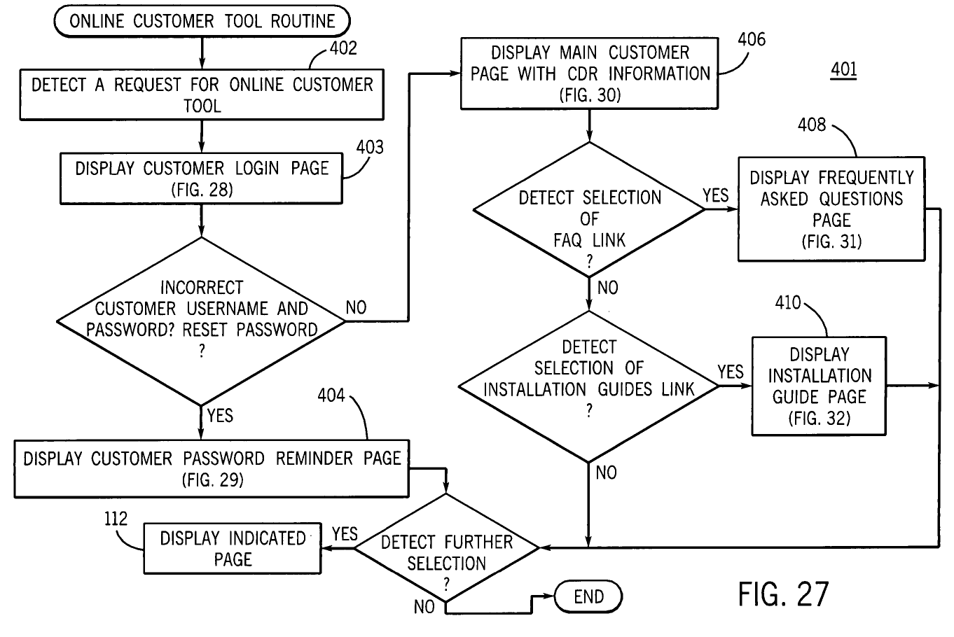

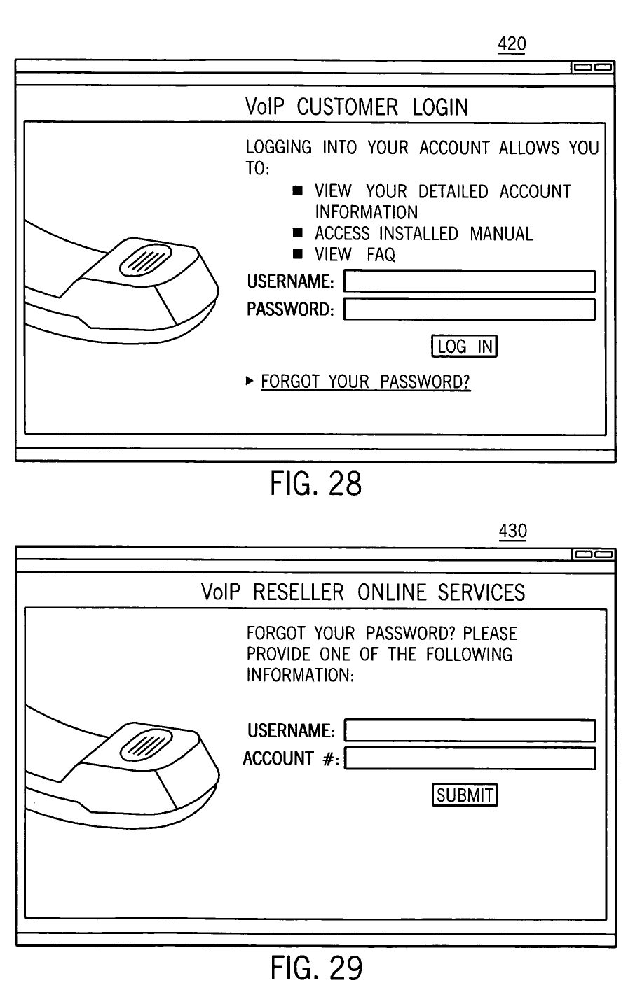

For example, FIG. 28 is a screen shot of an exemplary customer login page 420 of an online customer tool. As shown in FIG. 28, for security reasons, the customer is prompted for a username and a password. If the customer forgets his/her password, a customer password reminder page is displayed to enable the customer to request access to their account in the online customer tool. FIG. 29 is screen shot of an exemplary customer password reminder page 430 of the online customer tool enabling the customer to access their password (received via email) upon entering his/her username and account number.

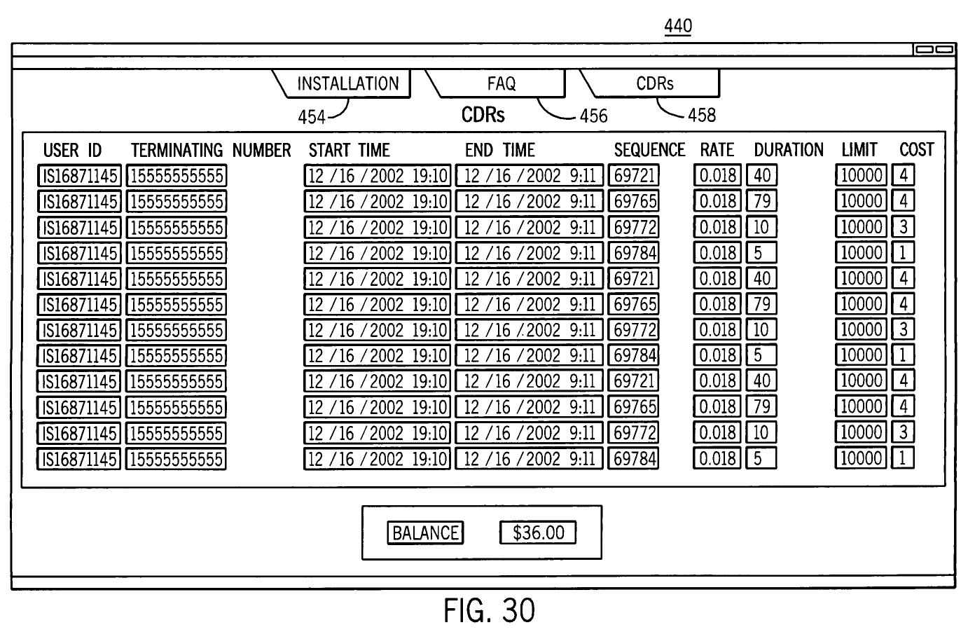

Upon detecting successful entry the customer's user name and password, the controller 66 enables customer access to a customer CDR page displaying their call detail records (step 404). For example, FIG. 30 is screen shot of an exemplary customer CDR page 440 of the online customer tool enabling the customer to view their call detail records and the remaining balance amount associated with their provisioned VoIP products. As illustrated by FIG. 30, and although not exhaustive, the call detail record may include a list of call entries where each call entry includes the customer's. IS#, or UID, which uniquely identifies that customer, the terminating number (i.e., the called number, prefixed by the country code), the call start date and time, the call end date and time, the sequence number of the call detail record, the rate applied to the call (in U.S. dollars), the duration of the call, the credit limit for the customer's account, and the cost of the call (in U.S. cents).

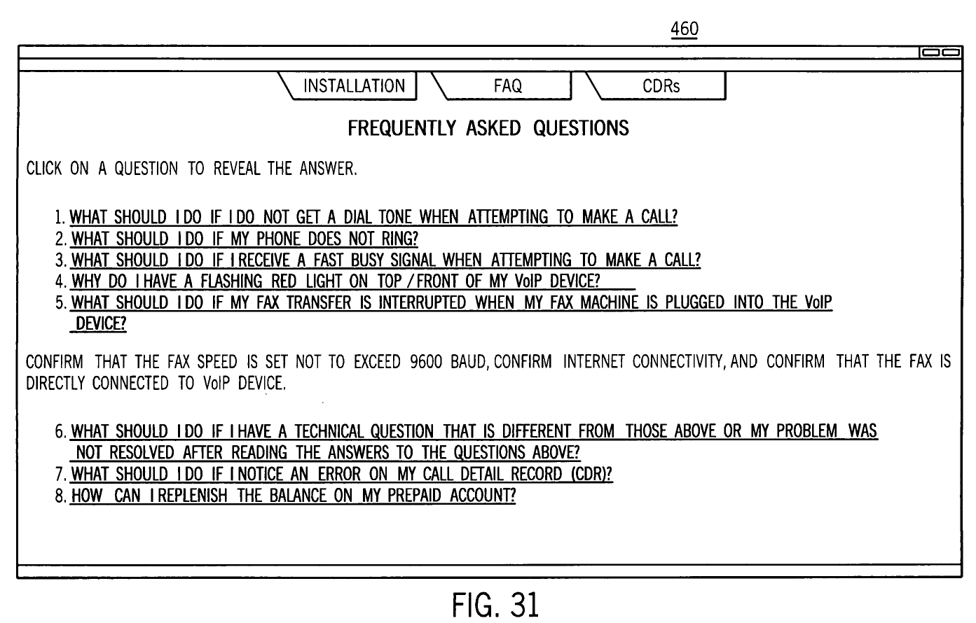

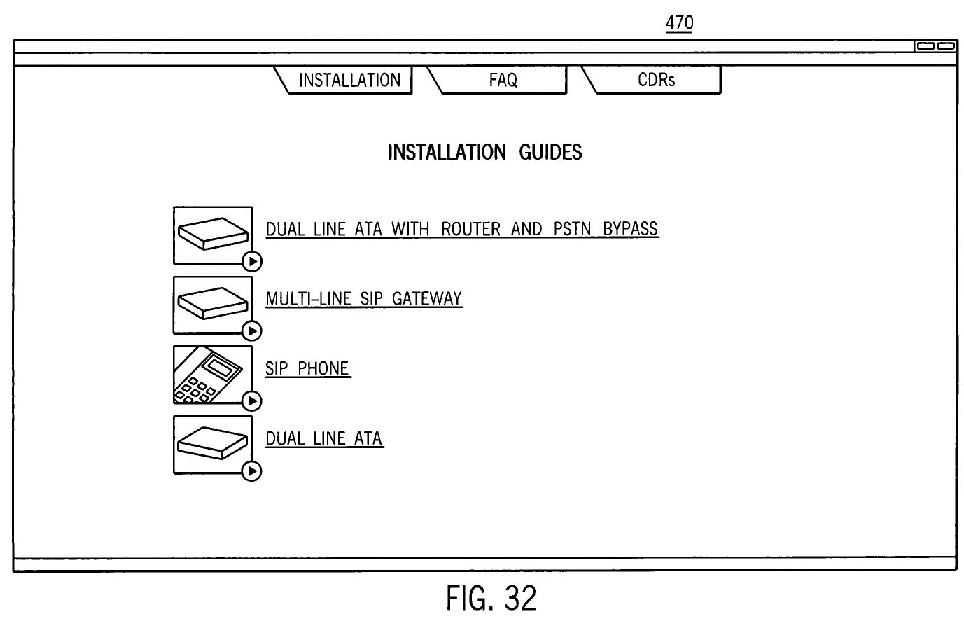

The customer CDR page 440 also includes tab links to additional web pages. Selection of the FAQ tab link 456 causes the controller 66 to display a FAQ web page. FIG. 31 illustrates a screen shot of an exemplary FAQ 460 page of the online customer tool. Selection of the Installation tab link 454 causes the controller 66 to display an installation guides web page. FIG. 32. illustrates a screen shot of an exemplary installation guide 480 page of the online customer tool. In this way, the customer can monitor aspects of his/her provisioned VoIP telephony products.

(5) Providing an Administration Tool Enabling an ITSP to Manage a Plurality of Financial Functions Associated with Purchases of the Plurality of VoIP Products

An administration tool is preferably provided to enable the ITSP to perform a number of financial functions associated with providing provisioned VoIP products. These functions may include setting pre-payment amounts (e.g., the reseller's deposit amount) or credit limits, setting discount percentages, setting rate table to be used for prepaid VoIP products purchased by resellers, viewing the resellers credit balances and the like, matching reseller's payments to their accounts, to name a few.

(6) Providing a Technical Support Scheme to ITSP Resellers and Customers

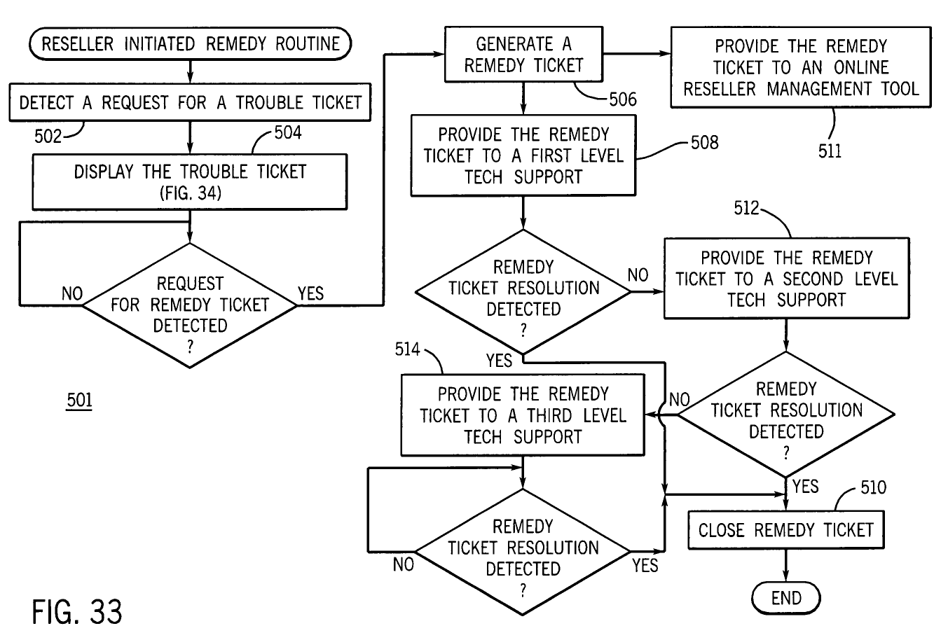

Workflow or technical support is preferably included to enable the ITSP to provide technical VoIP product support the reseller and to enable both the reseller and the ITSP to provide technical VoIP product support to the customer. For example, FIG. 33 is a flowchart of a reseller initiated remedy routine 501 for providing technical support to resellers and customers of VoIP products according to an embodiment of the present invention. Referring to FIG. 33, the reseller initiated remedy routine 501 begins when a request for an online trouble ticket is received (step 502). The trouble ticket is typically initiated due to a problem with a provisioning device associated with delivery of the purchased VoIP products. The trouble ticket may be initiated directly by the reseller or by an account manager on behalf of a reseller.

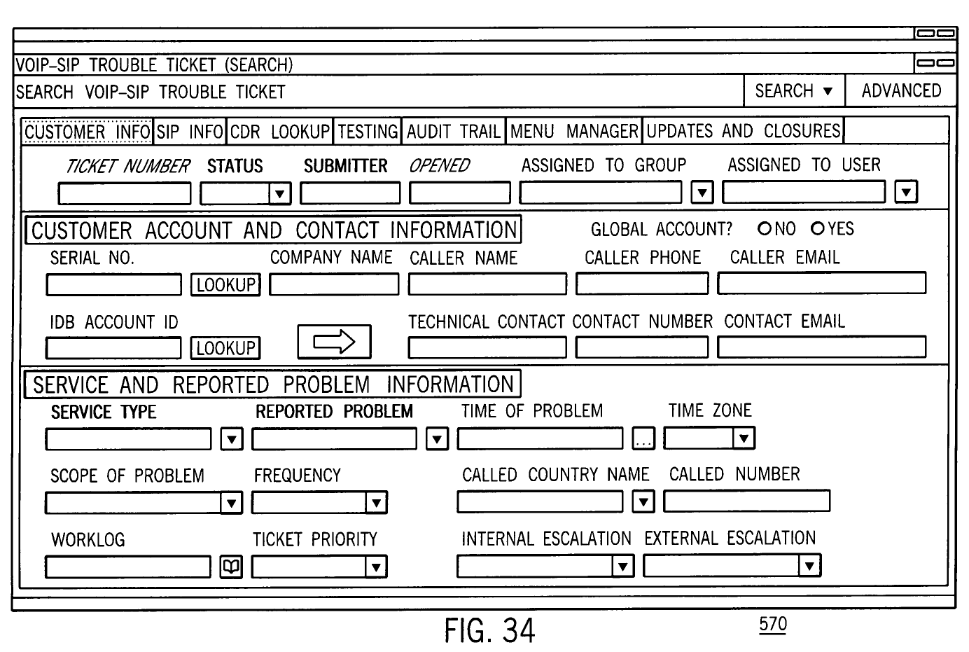

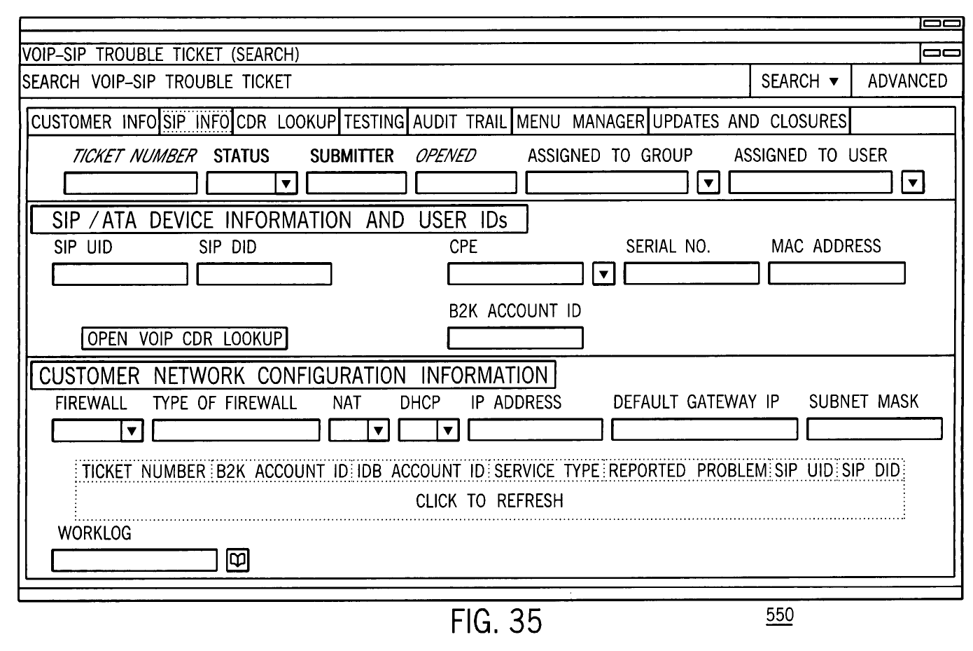

In response to the request for the trouble ticket, the controller 66 displays the online trouble ticket page (step 504). FIG. 34 is an exemplary VoIP trouble ticket page 550 that may be used in conjunction with the reseller initiated remedy routine 501 to generate an online trouble ticket 551. In the illustrated example, the exemplary VoIP trouble ticket page 550 may include a Customer Information tab 552, a SIP Information tab 554, a CDR lookup tab 556, a Testing tab 558, an Audit Trail tab 560, a Menu Manager tab 562, and an Updates and Closures tab 564, having a number of searchable fields. For example, FIG. 35 is a screen shot of an exemplary SIP Information page 570 selectable via the SIP Information tab 554.

Next, a remedy ticket 553 associated with the trouble ticket 551 is generated (step 506) is response to receiving a request. The request for the remedy ticket 553 may be initiated by an account manager on behalf of a reseller, by a reseller on behalf of a customer, and directly by the reseller or the customer, depending on their status with the ITSP. Upon completion of the remedy ticket 553, it is made available to a first level tech support (step 508), preferably via an online tech support tool. Similarly, the remedy ticket is made available to the online reseller management tool (and possibly the online customer management tool) (step 511) for access by resellers and customers.

Upon receipt of the remedy ticket 553, the first level tech support may do one or more of the following depending on the problem. The first level tech support confirms the operating system and physical connections of the device, verifies the customer's account, determined the device compatibility with the associated ITSP infrastructure, performs test SIP VoIP calls and analysis of failed call terminations, and confirms ISP connection and functionality. If the problem is resolved by the first level tech support, the resolution is indicated on the remedy ticket 553 and the ticket is closed (step 510).

If the problem is not resolved by the first level tech support, the remedy ticket 553 is provided to the second level tech support (step 512). Upon receipt of the remedy ticket 553, the second level tech support may do one or more of the following depending on the problem. The second level tech support verifies the trouble shooting steps performed by the first level tech support, and performs analysis of the ITSP gateway and associated network. If the problem is resolved by the first level tech support, the resolution is indicated on the remedy ticket 553 and the ticket is closed (step 510).

If the problem is not resolved by the second level tech support, the remedy ticket 553 is provided to the third level tech support (step 514). The third level tech support performs, among other things, a detailed analysis of the device, and configuration and network operability. The third level tech support resolves the problem, provides a resolution indication on the remedy ticket 553 and the ticket is closed (step 510).

While several embodiments of the disclosure are shown and described, it is envisioned that those skilled in the art may devise various modifications and equivalents without departing from the spirit and scope of the disclosure.

1. A method for providing a plurality of Voice over Internet Protocol (VoIP) telephony products, each of the plurality of VoIP products providing VoIP telephony capability via an Internet telephony service provider (ITSP) network, the method comprising:
providing access to an online purchaser management tool to a plurality of purchasers, the online purchaser management tool enabling online purchasing of each of the plurality of VoIP telephony products;
detecting an order for at least one of the plurality of VoIP telephony products by a purchaser of the plurality of purchasers via the online purchaser management tool, the order including information for provisioning the at least one of the plurality of VoIP telephony products in the ITSP network;
forwarding the order to the ITSP network; and
receiving an order confirmation from the ITSP network, the order confirmation indicating purchasing and provisioning of the at least one of the plurality of VoIP products.

2. The method of claim 1, further comprising forwarding the order confirmation to the purchaser.

3. The method of claim 1, wherein the information for provisioning includes one or more of a provisioning device type, a corresponding serial number, a corresponding media access control address of the provisioning device and a corresponding location configuration of the provisioning device.

4. The method of claim 1, wherein the information for provisioning is provided by one of the purchaser and a provisioning device provider.

5. The method of claim 1, wherein the purchaser comprises a reseller of the at least one of the plurality of VoIP telephony products, the reseller selling the at least one of the plurality of VoIP telephony products to a customer, the customer receiving the VoIP telephony calling capability associated with the at least one of the plurality of VoIP products.

6. The method of claim 1, wherein the purchaser comprises a customer, the customer receiving the VoIP telephony calling capability associated with the at least one of the plurality of VoIP telephony products.

7. The method of claim 1, further comprising providing access to an online technical support tool to the plurality of purchasers, the online technical support tool configured to initiate and track a plurality of remedies for a plurality of problems with a number of purchased VoIP telephony products.

8. The method of claim 7, further comprising:
detecting a request for access to the online technical support tool;
soliciting information corresponding to a problem with one of the plurality of purchased VoIP telephony products; and
generating a remedy ticket in response to solicited information corresponding to the problem, the remedy ticket including customer and order information.

9. The method of claim 8, further comprising providing the remedy ticket to the purchaser via the online purchaser management tool.

10. The method of claim 8, wherein soliciting information corresponding to the problem comprises transmitting a trouble ticket page to the purchaser and detecting entry of information corresponding to the problem with one of the plurality of purchased VoIP telephony products via the trouble ticket page.

11. The method of claim 8, further comprising:
providing the remedy ticket to a plurality of technical support staff, the plurality of technical support staff configured in a multi-level arrangement adapted to provide respective escalation of the problem to remedy the problem.

12. The method of claim 1, further comprising providing customer access to an online customer tool, the online customer tool configured to enable the plurality of customers receiving VoIP calling capability associated with purchased VoIP telephony products to view information corresponding to respective purchased VoIP telephony products.

13. The method of claim 12, wherein the information corresponding to the respective purchased VoIP telephony products includes one or more of a call detail record, a frequently asked question and an installation guide.

14. The method of claim 1, wherein providing access to the online purchaser management tool further comprises:
detecting a request for access to the online purchaser management tool;
soliciting a purchaser username and a purchaser password; and
verifying the purchaser username and the purchaser password against a database of authorized purchasers.

15. The method of claim 14, wherein soliciting the purchaser username and the purchaser password comprises transmitting a purchaser login page to the purchaser and detecting the purchaser username and the purchaser password.

16. The method of claim 14, further comprising generating a purchaser VoIP services page in response to successful verification of the purchaser username and the purchaser password.

17. The method of claim 16, further comprising:
detecting a purchaser's request for product information; and
transmitting a product information page in response to detecting the purchaser's request for product information.

18. The method of claim 16, wherein detecting the order for at least one of the plurality of VoIP telephony products further comprises:
detecting a purchaser's request to place an order;
transmitting a product order page in response to detecting the purchaser's request to place an order;
detecting purchaser selection of the at least one of the plurality of VoIP telephony products; and
soliciting the information for provisioning the at least one of the plurality of VoIP telephony products.

19. The method of claim 18, wherein soliciting the information for provisioning comprises transmitting an equipment provider information page to the purchaser and detecting purchaser selection of a customer option displayed on the equipment provider information page.

20. The method of claim 19, further comprising:
transmitting a customer provided equipment information order page;
detecting the provisioning device type, the corresponding serial number and the corresponding media access control address of the provisioning device.

21. The method of claim 20, wherein the order for the at least on of the plurality of telephony products includes a provisioning device type, a corresponding serial number and a corresponding media access control address of the provisioning device.

22. The method of claim 18, wherein soliciting the information for provisioning comprises transmitting an equipment provider information page to the purchaser and detecting purchaser selection of an ITSP option displayed on the equipment provider information page.

23. The method of claim 22, further comprising:
transmitting an ITSP provided equipment configuration order page; and
detecting a location configuration of a provisioning device provided by the ITSP.

24. The method of claim 23, wherein the order for the at least one of the plurality of telephony products includes one or more of a provisioning device type, a network address translation, a direct inward dialing number and a proximity to a firewall location.

25. The method of claim 16, further comprising:
detecting a purchaser's request for a purchaser customer list; and
transmitting a purchaser customer list page in response to detecting the purchaser's request for the purchaser customer list.

26. The method of claim 16, further comprising:
detecting a purchaser's request for balance information; and
transmitting a balance information page in response to detecting the purchaser's request for balance information.

27. The method of claim 16, further comprising:
detecting a purchaser's request for trouble ticketing; and
transmitting a trouble ticketing page in response to detecting the purchaser's request for trouble ticketing.

28. The method of claim 27, further comprising:
detecting a purchaser's request to view an existing trouble ticket;
transmitting a trouble ticket query page in response to detecting the purchaser's request to view an existing trouble ticket;
detecting entry of a customer identity number in a customer identity field of the trouble ticket query page; and
transmitting at least one existing trouble ticket in response to detecting entry of the customer identity number.

29. The method of claim 27, further comprising:
detecting a purchaser's request to create a new trouble ticket;
transmitting a new trouble page in response to detecting the purchaser's request to create a new trouble ticket.

30. A method for providing a plurality of Voice over Internet Protocol (VoIP) telephony products to a plurality of resellers, each of the plurality of VoIP products providing VoIP telephony capability via an Internet telephony service provider (ITSP) network, the method comprising:
providing access to the online reseller management tool to the plurality of resellers, the online reseller management tool enabling online purchasing of each of the plurality of VoIP telephony products and management of corresponding customer accounts;
interfacing, via the online reseller management tool, an order placed by a reseller of the plurality of resellers for at least one of the plurality of VoIP telephony products with the ITSP network; and
interfacing, via the online reseller management tool, the plurality of resellers with one or more reseller management databases, the reseller management database including one or more of a reseller's customer list, a reseller's balance, a trouble ticket and an order summary.

31. The method of claim 30, further comprising:
detecting a request for access to the online reseller management tool by a reseller of the plurality of resellers; transmitting a reseller login page to the reseller;
receiving a reseller username and a password from the reseller;
verifying the reseller username and the password against a database of authorized resellers; and
transmitting a reseller VoIP services page to the reseller, the reseller services page enabling reseller purchase and corresponding reseller management of at least one of the plurality of VoIP telephony products.

32. The method of claim 31, further comprising:
detecting reseller's request for product information; and
transmitting a VoIP product information page in response to detecting reseller's request for product information, the VoIP product information page including a list of the plurality of VoIP telephony products.

33. The method of claim 32, wherein the product information page further includes a plurality of order links corresponding to respective VoIP telephony products of the plurality of VoIP telephony products, reseller selection of one of the plurality of order links enabling reseller access to a plurality of ordering pages of the online reseller management tool, the plurality of ordering pages enabling reseller ordering and purchasing of the corresponding VoIP telephony product.

34. The method of claim 31, further comprising:
detecting a reseller's request for a product order;
transmitting a product order page in response to detecting the reseller's request for a product order;
detecting reseller selection of at least one of the plurality of VoIP telephony products; and
transmitting an equipment provider information order page in response to detecting reseller selection of the at least one of the plurality of VoIP telephony products, the equipment provider information order page including reseller selection of a provisioning device provider.

35. The method of claim 34, further comprising:
detecting reseller selection of a customer option displayed on the equipment provider information order page, the customer option indicating that the provisioning device provider is a customer purchasing from the reseller the at least one of the plurality of VoIP telephony products;
transmitting a customer provided equipment information order page in response to detecting reseller selection of the customer option, the customer provided equipment information order page enabling the reseller to indicate a provisioning device type, a corresponding serial number and a corresponding media access control address of the provisioning device provided by the customer;
detecting the provisioning device type, the serial number and the media access control address of the provisioning device provided by the customer;
forwarding an order for the one of the plurality of VoIP telephony products selected by the reseller to the ITSP network, the order including data corresponding to the provisioning device provided by the customer; and
receiving an order confirmation from the ITSP network, the order confirmation indicating purchasing and provisioning of the at least one of the plurality of VoIP products.

36. The method of claim 34, further comprising:
detecting reseller selection of an ITSP option displayed on the equipment provider information order page, the ITSP option indicating that the provisioning device provider is the ITSP of the ITSP network;
transmitting an ITSP provided equipment configuration order page in response to detecting reseller selection of the ITSP option, the ITSP provided equipment configuration order page enabling the reseller to select a location configuration of the provisioning device provided by the ITSP;
detecting reseller selection of the location configuration of the provisioning device provided by the ITSP;
forwarding an order for the at least one of the plurality of VoIP telephony products to the ITSP network, the order including the location configuration of the provisioning device provided by the ITSP; and
receiving an order confirmation from the ITSP network, the order confirmation indicating successful purchasing and provisioning of the at least one of the plurality of VoIP products.

37. The method according to claim 36, further comprising:
transmitting a direct inward dialing configuration order page if the reseller selection of the location configuration of the provisioning device provided by the ITSP includes a request for a direct inward dialing number, the direct inward dialing configuration order page enabling selection of at least one direct inward dialing number of a plurality of direct inward dialing numbers; and
detecting reseller selection of at least one direct inward dialing number from the plurality of direct inward dialing numbers.

38. The method of claim 31, further comprising:
detecting a reseller's request for a reseller customer list; and
transmitting a reseller customer list page in response to detecting the reseller's request for a reseller customer list, the reseller customer list page displaying a list of a plurality of customers who purchased VoIP telephony products from the reseller.

39. The method of claim 38, wherein the reseller customer list page further includes a plurality of customer related hyperlinks corresponding to the plurality of customers who purchased VoIP telephony products from the reseller, reseller selection of one of the customer related hyperlinks enabling reseller access to one of a plurality of customer related data pages.

40. The method of claim 39, wherein each of the customer related data pages is selected from the group consisting of a customer call detail record page, a customer trouble ticket page and a customer detail page.

41. The method of claim 31, further comprising:
detecting a reseller's request for balance information; and
transmitting a balance information page in response to detecting the reseller's request for balance information, the balance information page displaying a reseller credit balance for purchasing the plurality of VoIP products and enabling the reseller to make payments to increase the reseller credit balance.

42. The method of claim 31, further comprising:
detecting a reseller's request for trouble ticketing; and
transmitting a trouble ticketing page in response to detecting the reseller's request for trouble ticketing, the trouble ticketing page including a plurality of trouble ticketing hyperlinks displayed on the trouble ticketing page.

43. The method of claim 42, further comprising:
detecting reseller selection of a first trouble ticketing hyperlink from the plurality of trouble ticketing hyperlinks; and
transmitting a trouble ticket page in response to detecting reseller selection of the first trouble ticketing hyperlink, the trouble ticket page enabling the reseller to create a new trouble ticket corresponding to a problem with VoIP capability associated with a VoIP product purchased by the reseller.

44. The method of claim 42, further comprising:
detecting reseller selection of a second trouble ticketing hyperlink from the plurality of trouble ticketing hyperlinks; and
transmitting a trouble ticket query page in response to detecting the reseller selection of the second trouble ticketing hyperlink, the trouble ticket query page enabling the reseller to view at least one existing trouble ticket.

45. The method of claim 44, further comprising transmitting at least one existing trouble ticket in response to detecting entry of a customer identity number in a customer identity field of the trouble ticket query page.

46. The method of claim 44, further comprising transmitting at least one existing trouble ticket in response to detecting entry of a trouble ticket number in a trouble ticket field of the trouble ticket query page.

47. In an internet telephony service provider (ITSP) network coupled to the Internet, a system for providing a plurality of Voice over Internet Protocol (VoIP) telephony products, each of the plurality of VoIP products providing VoIP telephony capability via the ITSP network, the apparatus comprising:
a first server operatively coupled to the Internet, the first server comprising a first controller, the first controller having a processor and a memory coupled to the processor of the first controller, the first controller being programmed to:
provide an online tool to a plurality of purchasers, the online tool enabling online purchasing of each of the plurality of VoIP telephony products,
detect an order for at least one of the plurality of VoIP products by a purchaser via the online tool, the order including data for provisioning the least one of the plurality of VoIP products in the ITSP network, and
forward the order; and
a second server coupled to the first server, the second server comprising a second controller, the second controller having a processor and a memory coupled to the processor of the second controller, the second controller being programmed to:
receive the order,
verify an account balance of the purchaser,
provision the at least one of the plurality of VoIP products in the ITSP network, and
forward an order confirmation to the first server, the order confirmation indicating purchasing and provisioning of the at least one of the plurality of VoIP products.

48. The system according to claim 47, wherein the second controller is further programmed to:
request creation of an identification number by a billing system of the ITSP network, the identification number corresponding to the at least one of the plurality of VoIP products;
receive an identification number from the billing system in response to the request;
request creation of a customer account by a softswitch of the ITSP network, the customer account identified by the identification number;
request creation of an authentication record by an authentication system of the ITSP network, the authentication record identified by the identification number; and
request creation of a device configuration file by a device configuration server of the ITSP network, the device configuration file including the data for provisioning the least one of the plurality of VoIP products.

49. The system according to claim 48, wherein the first controller is further programmed to request the data for provisioning the least one of the plurality of VoIP products if a provisioning device for provisioning the at least one of the plurality of VoIP products is not provided by the ITSP network.

50. The apparatus of claim 47, wherein the purchaser comprises a reseller of the at least one of the plurality of VoIP products, the reseller selling the at least one of the plurality of VoIP products to a customer, the customer receiving the VoIP telephony calling capability associated with the at least one of the plurality of VoIP products.

51. The apparatus of claim 47, wherein the purchaser comprises a customer receiving the VoIP telephony calling capability associated with the at least one of the plurality of VoIP products.
